(19) United States
(12) Patent Application Publication
(10) Pub. No.: US 2026/0042057 A1
(43) Pub. Date: Feb. 12, 2026

(54) SYSTEMS AND METHODS FOR FORMATION, COMPACTION, SEALING, AND DISPOSAL OF CO2 HYDRATES ON THE SEABED

(71) Applicant: Board of Regents, The University of Texas System, Austin, TX (US)

(72) Inventors: Vaibhav Bahadur, Austin, TX (US); Awan Bhati, Austin, TX (US); Manojkumar Lokanathan, Austin, TX (US); Stephen E. Smaha, Austin, TX (US)

(21) Appl. No.: 19/099,558

(22) PCT Filed: Aug. 1, 2023
(86) PCT No.: PCT/US2023/029221

§ 371 Date: Jan. 29, 2025

Related U.S. Application Data
(60) Provisional application No. 63/394,009, filed on Aug. 1, 2022.

(51) Int. Cl. B01D 53/62; B01D 53/14; B01D 53/73; B01D 53/78; C01B 32/50

(52) U.S. Cl. CPC B01D 53/62; B01D 53/1475; B01D 53/1493; B01D 53/73; B01D 53/78; C01B 32/50; B01D 2252/103; B01D 2257/504

(57) ABSTRACT

Described herein are methods and systems for generating CO₂ clathrate hydrates, for compaction of CO₂ hydrates into a plug, and sealing the plug into a container to prevent dissociation of the plug. The disclosed methods and systems advantageously allow for the rapid formation of CO₂ clathrate hydrates in water and sealing the CO₂ clathrate hydrate in a container for long term storage on the seabed. CO₂ clathrate hydrates can be useful for CO₂ sequestration and securely storing the CO₂ clathrate hydrate as a solid.

### CROSS-REFERENCE TO RELATED APPLICATION

This application claims the benefit of and priority to U.S. Provisional Application No. 63/394,009, filed on Aug. 1, 2022, and titled “SYSTEMS AND METHODS FOR FORMATION, COMPACTION, SEALING, AND DISPOSAL OF CO2 HYDRATES ON THE SEABED,” the content of which is herein incorporated by reference in its entirety for all purposes.

### STATEMENT REGARDING FEDERALLY SPONSORED RESEARCH OR DEVELOPMENT

This invention was made with governmental support under grant nos. CBET1653412, 2202071, and 2234604, awarded by the National Science Foundation. The government has certain rights in the invention.

### FIELD

This invention is in the field of clathrate hydrate formation processes and CO₂ sequestration. This invention relates generally to formulation, compaction, sealing, and disposal of CO₂ hydrates on the seabed.

### BACKGROUND

Typically, industrial-scale CO₂ sequestration includes injecting CO₂ in depleted oil-gas reservoirs, saline aquifers, coal seams, and certain other geologic formations. To obviate the injection of CO₂ into preexisting geologic formations, synthetic mechanisms have been developed to sequester CO₂. Alternative CO₂ sequestration schemes, based on biosequestration are being developed, but are not currently practiced at large-scales.

### SUMMARY

Clathrate hydrates offer a plausible route for CO₂ sequestration. Clathrate hydrates are ice-like crystalline materials formed from a lattice of hydrogen bonded water molecules encapsulating a guest molecule or atom, such as a gas molecule or atom. Structurally, CO₂ hydrates comprise or consist of cages of water molecules which trap CO₂ molecules. On average, 6 water molecules trap 1 molecule of CO₂. 1 kg of solid CO₂ hydrate can sequester up to 290 grams of CO₂ (e.g., 150 liters of CO₂ at 25° C. & 1 atm). Also, CO₂ hydrates are denser than seawater (density: 1040-1160 kg/m³). Synthesis of clathrate hydrates requires specific temperature and pressure windows. Artificial synthesis of hydrates is very challenging due to limitations associated with mass transfer, chemical kinetics, and heat transfer.

Described herein are methods and systems for generating clathrate hydrates and, in particular, for formation of CO₂ hydrates, compaction of CO₂ hydrates into a plug, and sealing the plug inside an appropriate material (container) to prevent dissociation of hydrates in a seawater ambient. The disclosed methods and systems advantageously allow for the rapid formation of CO₂ clathrate hydrates in water and sealing the CO₂ clathrate hydrate in a container for long term storage on the seabed. CO₂ clathrate hydrates can be useful for CO₂ sequestration and securely storing the CO₂ clathrate hydrate as a solid. Other applications of clathrate hydrates include desalination, CO₂ capture from flue gases or other impure CO₂ streams and gas transport.

In a first aspect, methods for generating CO₂ clathrate hydrates are described. An example method of this aspect comprises subjecting CO₂ and a liquid comprising water to a clathrate hydrate formation conditions.

The clathrate hydrate formation conditions may generally include low temperature and high pressure. For example, the clathrate hydrate formation condition may comprise a pressure of greater than 150 psi, a pressure of from 150 psi to 4500 psi, or a pressure of more than 4500 psi. In some examples, the pressure may be generated via a column of water, such as may be present at the sea floor in the ocean. As another example, the clathrate hydrate formation condition may comprise a temperature of from about −25° C. to 25° C., depending on the pressure. It will be appreciated that clathrate hydrates can form at temperatures near the freezing temperature of water, and can form at different temperatures, depending on the pressure conditions, feed composition (e.g., gas or liquid mixtures), and/or liquid composition (e.g., presence of salts or promoters in water). In some examples, the clathrate hydrate formation conditions include a temperature of from about −5° C. to about 10° C.

In some examples, the CO₂ may be in the form of gas bubbles rising through the liquid under the clathrate formation condition. Flow rates for the CO₂ gas injection into a hydrate formation vessel can be of a sufficient level to generate amounts of CO₂ hydrates such that the CO₂ hydrates can be captured and accumulated. In some examples, the flow rate of CO₂ may be from 0.5 g per minute per liter of liquid exposed to the CO₂ to 400 g per minute per liter of liquid, or more. In some examples the volume of liquid exposed to the CO₂ may be the volume of liquid inside a hydrate formation vessel. The flow of bubbles under such CO₂ flow conditions may provide an environment for rapid generation of CO₂ hydrates. In some examples, the flow rate of CO₂ may be from 0.5 g/min·L to 1 g/min·L, from 1 g/min·L to 5 g/min·L, from 5 g/min·L to 10 g/min·L, from 10 g/min·L to 20 g/min·L, from 20 g/min·L to 30 g/min·L, from 30 g/min·L to 40 g/min·L, from 40 g/min·L to 50 g/min·L, from 50 g/min·L to 60 g/min·L, from 60 g/min·L to 70 g/min·L, from 70 g/min·L to 80 g/min·L, from 80 g/min·L to 90 g/min·L, from 90 g/min·L to 100 g/min·L, from 100 g/min·L to 150 g/min·L, from 150 g/min·L to 200 g/min·L, from 200 g/min·L to 250 g/min·L, from 250 g/min·L to 300 g/min·L, from 300 g/min·L to 350 g/min·L, from 350 g/min·L to 400 g/min·L, or more.

In some examples, convection currents generated via the rising bubbles can provide a mechanical mixing mechanism, obviating the need for mechanical stirring devices within a hydrate formation vessel. In some examples, the flow rate of the CO₂ gas into a hydrate formation vessel may limit the generation rate of the clathrate hydrate, and so it may be desirable to use as high a CO₂ gas flow rate as practicable. In some examples, a large fraction of the CO₂ is not converted into CO₂ hydrates (as it bubbles through the liquid), so the excess CO₂ may be captured and recirculated for additional passes through the liquid.

In some examples, CO₂ hydrates are formed using liquid CO₂ and water. For example, the CO₂ may be in the form of liquid CO₂ droplets falling through the liquid comprising water under the clathrate formation condition. For example, liquid CO₂ droplets may be dispensed in a reactor at least partially filled with water, and may fall down a length of the reactor, forming CO₂ hydrates along the way. In some other examples, CO₂ hydrates are formed from an emulsion of liquid CO₂ in water, such as a liquid CO₂-in-water (C/W) emulsion or a water-in liquid CO₂ (W/C) emulsion. In some examples, such emulsions can be stabilized by surfactants (e.g., SDS) amino acids (e.g., tryptophan) or by hydrophobic or hydrophilic particulates (e.g., silica, calcium carbonate etc.), and subjected to the clathrate formation condition to generate CO₂ hydrates.

Advantageously, the methods of this aspect may be used to generate clathrate hydrates using water or a water-based liquid. For example, the liquid may be or comprise at least one of sea water, fresh water, processed water, produced water, purified water, brackish water, hypersaline water, brine, or water including an ion concentration (optionally exclusive of H⁺ ions and OH− ions) or salt concentration in a range from 0% to 5% by weight, such as from 0% to 0.5%, from 0.5% to 1%, from 1% to 1.5%, from 1.5% to 2%, from 2% to 2.5%, from 2.5% to 3%, from 3% to 3.5%, from 3.5% to 4%, from 4% to 4.5%, from 4.5% to 5%, or more.

Molecules or atoms of a gas, such as CO₂, may be captured or hosted by the clathrate hydrate, which can allow for significant amounts of the gas atoms to be present in a solid hydrate form at reasonable temperatures, such as temperatures at, about equal to, or above the freezing temperature of water, though formed clathrate hydrates can be cooled to below the freezing temperature of water. As an example, CO₂ that is subjected to clathrate hydrate formation conditions with the liquid may comprise at least one of gaseous CO₂, liquid CO₂, or dissolved CO₂, but generally the clathrate hydrate formation conditions will be such that the CO₂ will be in gaseous form. The CO₂ may be pure or include impurities. In some cases, the CO₂ may have a purity of at least 10%, at least 20%, at least 30%, at least 40%, at least 50%, at least 60%, at least 70%, at least 80%, at least 90%, at least 95%, or at least 99%, such as by weight or volume. Various other gases may be present in the flow with CO₂, such as N₂, O₂, H₂O, SOₓ, NOₓ, etc. and make up the remainder or be present as impurities in the CO₂. In some cases, the CO₂ may be sparged, bubbled, or sprayed into the liquid. Optionally, a method of this aspect further comprises generating the CO₂ by way of a chemical reaction. The CO₂ may comprise CO₂ captured, and optionally purified, from a CO₂ generation source, such as a combustion source (e.g., a natural gas burner, a fossil fuel power station, etc.). In some cases, the incorporation of CO₂ into clathrate hydrates from a CO₂ generation source may function to capture the CO₂ present in a fluid stream, such as a waste or exhaust stream or flue gas stream, from the CO₂ generation source. Such techniques may be useful with low-purity (e.g., less than 30%) CO₂ streams.

In some cases, various techniques can be employed to enhance or promote hydrate formation. For example, mechanical stirring, magnetic stirring, the use of chemical promoters (e.g., surfactants, amino acids), the use of electric fields, magnetic fields, acoustics, and/or the use of metals and alloys for nucleation promotion (magnesium, aluminum, calcium) can occur or be present within or under the clathrate formation condition (e.g., with a hydrate formation vessel), such as for purposes of enhancing nucleation, formation, and/or growth of the hydrates.

In some examples, an airlift reactor may be used for nucleating, forming, or growing hydrates. In some examples, other reactor configurations (e.g., a bubble column reactor) may be susceptible to plugging, which can be avoided in an airlift reactor by the presence of an internal draft tube that can enhance mixing. For example, gas introduced via sparging at the bottom can flow through a riser section and pass or escape to or through the top of the reactor, while the liquid and/or hydrates can flow downwards in a gas-free downcomer section. Other reactor configurations besides bubble column reactors and airlift reactors can be used.

In some examples, hydrate formation may occur or be driven using generation or presence of appropriately sized bubbles under the clathrate formation conditions. Such bubbles can be generated by sparging or any other techniques for generating bubbles. In some examples, bubbles may be generated by any of a variety of techniques, such as, but not limited to, acoustic cavitation, electrolysis of water, sparging, boiling using localized heating, carrying out localized chemical reactions that produce gases, etc. All of these techniques are useful for generating gas bubbles ranging in size from 100 nm to 1 cm in diameter, for example.

Optionally, the formation of clathrate hydrates may include the use of gases other than CO₂, with the objective of using this non-CO₂ gas injection to enhance CO₂ hydrate formation. For example, the gas injected into a hydrate formation vessel can include gases such as O₂, CH₄, and/or in some cases inert gases, like N₂ or Ar. For example, the hydrate formation vessel can include a liquid comprising water and CO₂. The liquid can be pressurized to an appropriate pressure for initiating the formation of the clathrate hydrate and CO₂, and optionally other gases, can be injected into the hydrate formation vessel through the sparger to generate a plurality of bubbles within the hydrate formation vessel. The bubbles may range in size from 100 nm to 1 cm in diameter.

In another example, the liquid comprising water under the clathrate formation condition may not occur or exist in a continuous phase. Optionally, the liquid may be sprayed or misted into the hydrate formation vessel (e.g., a bubble column reactor) comprising the CO₂ gas. For example, misting liquid into the hydrate formation vessel may enhance heat and mass transfer, as compared to other configurations, and can enhance hydrate interface breakdown, resulting in increased growth.

In some examples, hydrate formation can occur in the presence of materials that drive or speed up removal of heat. Optionally, a hydrate formation vessel can include a material with a higher thermal conductivity than water, such as in the form of a foam, mesh, or particles of the material, which may include for example metal or a high thermal conductivity polymer.

Optionally, a hydrate formation vessel can include a guideway, baffles, or other structures that increase the residence time of bubbles inside the hydrate formation vessel. Optionally, guideway, baffles, or other structures can be made of a material having a high thermal conductivity (e.g., higher than water, such as metal or a high thermal conductivity polymer) to improve heat transfer. In some examples, a guideway inside a hydrate formation vessel can have a helical shape, though other shapes or configurations may be used.

In some examples, the hydrate formation vessel can be operated in a batch mode process to generate batches of hydrates. Due to the generally low formation rate of hydrates, the hydrate formation vessel may be operated in a continuous mode to continuously generate hydrates.

In some cases, subjecting the liquid and the CO₂ to the clathrate hydrate formation condition may occur on land, at a water surface level, or at a depth under a water column (e.g., subsurface depth or sea floor depth), such as in a hydrate formation vessel positioned on land, at the water surface level, at the sea floor, or at a subsurface position (e.g., between the water surface and the sea floor). Where the hydrates are generated on land, at the water surface level, or at a subsurface position, the hydrates can be transported to the seabed for long-term storage. For example, the hydrates can be transported by pipeline. In some cases, the hydrates may be formed into hydrate plugs and packaged into sleeves or containers on land or at the sea surface and transported to the sea floor for disposal on the seabed. Optionally, the hydrates may be transported to the sea floor as a slurry (e.g., containing solid hydrate crystals, trapped gas, and/or unreacted water) and formed into hydrate plugs and packed into sleeves or containers at or above the sea floor. Hydrate slurries can be formed on land, on an offshore oil-gas platform, or on the seabed, and these slurries can then be transported (e.g., via pipelines or other means) to the sequestration site. At the sequestration site, hydrate slurries can be used to form hydrate plugs (for sequestration after sealing) by removing excess water from the slurry (e.g., via a compaction chamber). The unreacted water and trapped gas in the slurries can convert to hydrate during transportation, which is advantageous.

In some examples, hydrate slurries or compacted hydrate plugs that are or are not enclosed in a sleeve or container may be used for marine carbon storage, such as where the hydrate slurries or compacted hydrate plugs are transported below a seafloor surface (e.g., under marine sediments or in sedimentary zones) to store the hydrates, including trapped CO₂, under the seafloor. In some cases, such techniques can provide suitable drop-in replacements for other CO₂ sequestration techniques where gaseous, liquid, or supercritical CO₂ is injected below a seafloor. In this way, the materials above or comprising the seafloor (e.g., marine sediments or sedimentary zones) can serve to enclose, act as a container, and/or otherwise house and/or protect the hydrates for storage and sequestration of CO₂.

For use of a hydrate formation vessel, some methods of this aspect may further comprise maintaining the CO₂ and the liquid at the clathrate hydrate formation condition using a pressure controller in communication with the pressure vessel. Methods of this aspect may comprise subjecting the CO₂ and the liquid to the clathrate hydrate formation condition by removing heat from the hydrate formation vessel via direct or indirect contact with a heat exchanger. Methods of this aspect may comprise maintaining the CO₂ and the liquid at the clathrate hydrate formation condition using a temperature controller in communication with the heat exchanger. Methods of this aspect may involve heat removal using active (power-consuming) and passive (non-power-consuming) cooling techniques.

In some examples, the hydrate formation vessel may be a bubble column reactor. The bubble column reactor may be a cylindrical or cuboidal or have any other shape that may have a high aspect ratio for prolonging the bubble lifetime inside the water phase of the reaction vessel. In some examples, the reaction vessel may include optical windows along the length of the column to visualize the bubbles or the gas-liquid interface at the surface of the bubbles. Optionally, the system further comprises one or more pumps in fluid communication with the hydrate formation vessel for generating a pressure in the vessel associated with the clathrate hydrate formation condition and/or for injecting gaseous CO₂ into the vessel. Optionally, the system further comprises a pressure controller in fluid communication with the vessel and in control communication with the pump for controlling the pressure in the vessel. Optionally, the system further comprises a heat exchanger in thermal communication with the liquid or the vessel, to be used for generating a temperature in the vessel associated with the clathrate hydrate formation conditions.

Once CO₂ hydrates are formed, the CO₂ hydrate may optionally rise or be carried to the top of the hydrate formation vessel or a liquid therein (e.g., to a gas-liquid interface) and may be extracted out of the hydrate formation vessel. In some examples, however, the CO₂ hydrate may optionally sink or be carried to the bottom of the hydrate formation vessel or a liquid therein. As amounts of CO₂ hydrates are generated, they may be accumulated into the form of a slurry, which may be transported out of the hydrate formation vessel, for example using a slurry pump (or other pumps) or a mechanical sweeping process. A containment chamber may be positioned in fluid or flow communication with the hydrate formation vessel for storing the hydrate slurry for subsequently generating a plug from the hydrate slurry.

In some examples, systems and techniques described herein may employ or comprise a containment chamber. The containment chamber may be a housing unit for collecting and/or compacting the generated CO₂ hydrates. In some examples, the containment chamber may further comprise, internally, one or more compaction chambers and optionally one or more collection chambers (accumulators). Optionally, the containment chamber may be in fluid communication with the hydrate formation vessel for receiving the CO₂ hydrates or a slurry of CO₂ hydrates and transporting into the compaction chamber. The containment chamber may further be in fluid communication with an inlet manifold or other CO₂ source for injecting CO₂ into the containment chamber to create a CO₂ rich environment within the containment chamber and/or to maintain a pressure within the containment chamber. Optionally, the hydrate formation vessel may be in fluid communication with more than one collection chambers for temporary storage and/or accumulation of the CO₂ hydrates or CO₂ hydrate slurry.

Optionally, the compaction chamber may operate in a batch mode for generating compacted CO₂ hydrates. In some examples, the compaction chamber may include a piston actuation mechanism for generating a hydrate plug by compacting the hydrate slurry to remove excess water. For example, the mechanism for controlling the piston actuation mechanism may be hydraulic actuation. Optionally, the compaction of the CO₂ hydrate can be carried out, at least in part, in the hydrate formation vessel. Following formation of the clathrate hydrate the piston actuation mechanisms can generate a hydrate plug directly within the hydrate formation vessel; however, a batch process for the hydrate formation may be used in some cases.

In some examples, the containment chamber or a compaction chamber may be present within the hydrate formation vessel. As an example, a piston may be present at one end of the hydrate formation vessel (e.g., the top end), which can be used to compact hydrates that accumulate within the hydrate formation vessel, such as in a batch mode after accumulation of sufficient hydrates within the hydrate formation vessel. After compaction, the opposite end of the hydrate formation vessel can be opened to release a compacted hydrate plug.

In some examples, the compaction chamber may operate in a continuous mode for generating compacted CO₂ hydrates. In some examples, a roll press may be used to compress or compact the collected CO₂ hydrates and form a CO₂ hydrate sheet plug, which can optionally be further manipulated after compaction to form the CO₂ hydrate sheet plug into another shape.

Systems for sealing the hydrate plugs for long-term storage and disposal on the seabed are also described, in another aspect. A system of this aspect, for example, comprises a sleeve receptacle positioned adjacent to the compaction chamber and housed within the pressure-controlled containment chamber. The pressure within the containment chamber may be at the same pressure as the hydrate formation vessel via injection of CO₂ into the containment chamber.

Subsequent to compaction into a hydrate plug, the compaction chamber may open to release the hydrate plug into the sleeve receptacle. The sleeve receptacle may comprise containers for storing the hydrate plugs. For example, the container may be a flexible sleeve that can store the hydrate plug within the sleeve while allowing for pressure transfer and for expansion and contraction of the sleeve to prevent CO₂ leak-off. In some examples, the material of the sleeve has sufficient tensile strength, tear strength, and burst resistance to prevent rupture, which would bring the CO₂ hydrate in contact with seawater. Furthermore, in some examples, the sleeve material is seawater resistant, CO₂ impermeable, and/or resistant to biofouling and/or photodegradation. Alternatively, the container may be a solid container comprising a lid and body, for example. As another example, concentric or nested sleeves or containers may be used, with smaller sleeves or containers housed within larger sleeves or containers and/or larger sleeves or containers housing smaller sleeves or containers, with space between each adjacent sleeve or container used to hold CO₂ clathrates and optionally CO₂ saturated liquid (e.g., CO₂ saturated water or seawater). Such a configuration can advantageously provide for multiple layers of protection of the enclosed clathrates in the event that a layer is compromised.

The sleeve receptacle or container may comprise a polymer, a flexible ceramic, and/or a composite, which may be inert and suitable for long-term protection and/or storage (e.g., 100 years or 1000 years or more) of the hydrate plug at the sea floor. For example, a polymer or composite may comprise one or more of polyethylene terephthalate, polyurethane, high-density polyethylene, ethylene propylene diene, ethylene propylene, ultra-high molecular weight polyethylene, low-density polyethylene, perfluoroelastomer, polyether ether ketone, polyetherimide, or any combination thereof. To maintain position of the sleeve receptacle or container, once filled with CO₂ hydrate, at the sea floor, the sleeve receptacle or container may optionally contain weighted portions or be weighted to ensure the density of the sleeve receptacle or container does not rise above the density of seawater. Advantageously, CO₂ hydrates may be generally denser than seawater, which may allow the filled sleeve receptacle or container to naturally have a higher density than seawater such that the filled sleeve receptacle or container can be held to the sea floor by gravity.

Advantageously, the sleeve receptacle or container may comprise one or more coatings on the inner surface and/or on the outer surface. The coating may provide functional properties, for example, resistance to seawater, resistance to CO₂ permeation, anti-fouling, anti-biofouling, resistance to photodegradation (e.g., UV degradation) and superhydrophobic properties. For example, a superhydrophobic coating may comprise a polystyrene composite, a fluorocarbon or fluoropolymer, a silane agent, a silica, nanoparticles, microparticles, or a nanostructured and/or microstructured surface. In some examples, an anti-fouling or superhydrophobic coating may be added to the surface of the sleeve receptacle or container to prevent the formation or accumulation of biological materials on the surface of the container, thus preventing breakage and potential CO₂ leakage from the sleeve receptacle or container. In some examples, the sleeve receptacle or container may encapsulate the hydrate plugs for long term storage on the seabed.

The sleeve receptacle or container, subsequent to sealing, may be disposed from the containment chamber for long-term storage along the seabed. In some examples, the containment chamber may comprise a trap door or other disposal region or unloading chamber. The containment chamber or the disposal region or unloading chamber may at least partially depressurize or fill with water to allow the trap door, disposal region or unloading chamber to open and dispose of the filled sleeve receptacle or container external to the containment chamber. In some examples, the system may further include a conveyer system for transport of the clathrate hydrate container to a destination away from the containment chamber (e.g., at least 10 feet from the containment chamber.

Without wishing to be bound by any particular theory, there can be discussion herein of beliefs or understandings of underlying principles relating to the invention. It is recognized that regardless of the ultimate correctness of any mechanistic explanation or hypothesis, an embodiment or example of the invention can nonetheless be operative and useful.

### BRIEF DESCRIPTION OF THE DRAWINGS

FIG. 1A provides a diagram illustrating an example system for forming, compacting and sealing CO₂ clathrate hydrates into a container in accordance with some examples described herein.

FIG. 1B provides a diagram illustrating positioning an example system for forming, compacting and sealing CO₂ clathrate hydrates at a subsea location remote from a CO₂ generation site.

FIG. 1C provides a diagram illustrating positioning some components of an example system for forming, compacting and sealing CO₂ clathrate hydrates at CO₂ generation site and other components at a subsea location remote from the CO₂ generation site.

FIG. 2A, FIG. 2B, and FIG. 2C provide diagrams illustrating an example container for storing the clathrate hydrate plug in accordance with some examples described herein.

FIG. 3A provides photographs of CO₂ bubbling prior to hydrate formation (t=0). FIG. 3B provides a photograph of CO₂ hydrate growth from interface towards water (t=2 min.) FIG. 3C provides a photograph of completion of CO₂ hydrate growth (t=5 min.).

FIG. 4 provides an overview of an example method for forming CO₂ clathrate hydrates, in accordance with some examples described herein.

FIG. 5 provides an overview of an example method for forming, compacting, and sealing CO₂ clathrate hydrates into a container, in accordance with some examples described herein.

FIG. 6 provides data showing time variation of reactor pressure, reactor temperature, inlet gas temperature, and water temperature during CO₂ hydrate formation experiments.

FIG. 7 provides data showing variation of reactor pressure and reactor temperature for two CO₂ hydrate compaction experiments and one experiment without compaction.

FIG. 8 provides a schematic illustration of a CO₂ hydrate formation reactor at different states, as well as images from inside the reactor at different times.

FIG. 9 provides a plot showing the influence of gas flow rate on sequestration rate, gas consumption for hydrate formation, gas consumption as unreacted gas trapped inside slurry, and mass of CO₂ sequestered in slurry per mass of water used.

FIG. 10 provides a plot showing the influence of gas flow rate on hydrate conversion fraction in a single pass and the density of hydrate slurry normalized with density of water.

FIG. 11 provides a plot showing the influence of formation time on sequestration rate, gas consumption for hydrate formation, gas consumption as unreacted gas trapped inside slurry, and mass of CO₂ sequestered in slurry per mass of water used.

FIG. 12 provides a schematic illustration of a setup used for CO₂ permeability experiments.

FIG. 13 provides a schematic illustration of a punch tool method for measuring shear strain.

FIG. 14 provides a schematic illustration of a setup used for accelerated thermal aging of polymers.

### DETAILED DESCRIPTION

Described herein are methods, systems, and techniques relating to the formation, compaction, sealing and disposal of CO₂ clathrate hydrates on the seabed. The disclosed methods, systems, and techniques can allow for artificial synthesis of CO₂ clathrate hydrates, for example, by injecting large flow rates of CO₂ into a hydrate formation vessel to generate bubbles within the liquid for forming CO₂ clathrate hydrates. The flow of CO₂ into the bottom of a hydrate formation vessel can generate a plurality of bubbles within the hydrate formation vessel. Advantageously, the methods, systems, and techniques described herein can allow for rapid generation of CO₂ clathrate hydrate by using large quantities of CO₂ to provide large quantities of bubbles. Such amounts of bubbles can provide for increased gas-liquid surface areas, which can permit increased formation rate and yield.

In general the terms and phrases used herein have their art-recognized meaning, which can be found by reference to standard texts, journal references and contexts known to those skilled in the art. The following definitions are provided to clarify their specific use in the context of the invention.

“Clathrate hydrate” refers to a crystalline or semi-crystalline or amorphous solid including water molecules in a cage-like structure containing a compound within the cage-like structure. Clathrate hydrates may also be referred to herein as hydrates or clathrates.

“Guest molecule” refers to a compound contained within a cage-like structure of a clathrate hydrate.

“Hydrate formation” or “hydrate generation” refers to the phase-change process by which a clathrate hydrate phase forms from a mixture of liquid and gas, or liquid and liquid.

“Long-term storage” refers to the storage of a compound for 100 years or more or 1000 years or more, without dissociation, or degradation, or loss of mass, or change in structure.

“Clathrate hydrate plug” or “plug” herein refers to a compressed form or hydrates in which excess liquid water has been removed and a majority of the structure comprises hydrates.

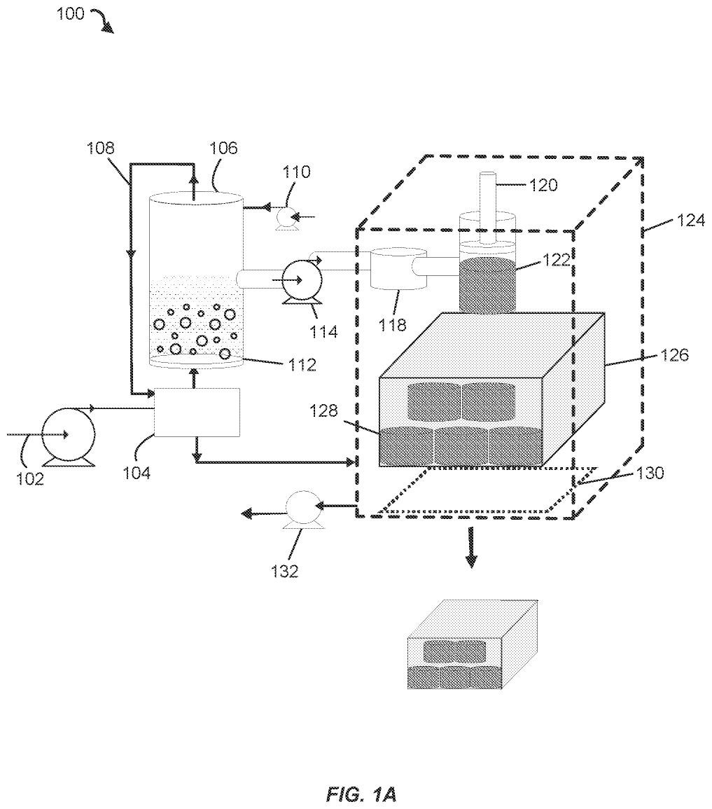

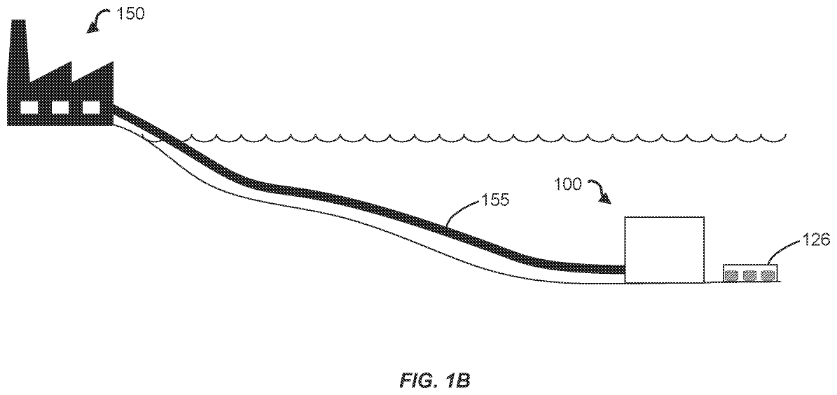

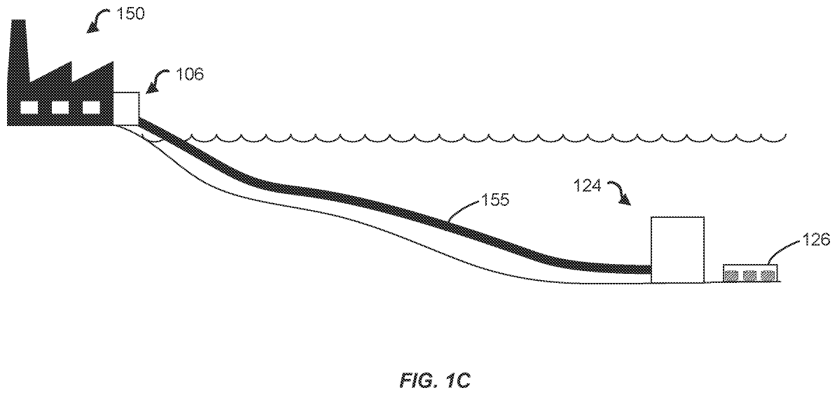

FIG. 1A provides a diagram illustrating an example system 100 for forming, compacting and sealing the CO₂ clathrate hydrate into a container, in accordance with some examples described herein. The gas 102, to be captured as a hydrate guest molecule, may be injected into the inlet manifold 104. The guest molecule 102 may include a composition that is normally a gas at atmospheric conditions. Examples of the hydrate guest molecule 102 include, but are not limited to, high purity (e.g., greater than 90%) carbon dioxide (CO₂) or low purity (e.g., 20% to 90%) carbon dioxide. In some examples, the gas 102 is a product of a combustion process or collected via a land-based plant and may be transported to system 100 via one or more pumps and/or fluid pipeline. In some examples, the gas is provided for hydrate formation via an inlet into a sparger 112 positioned within the bottom of a hydrate formation vessel 106. In some examples, the hydrate formation vessel 106 may be a bubble column reactor or an airlift reactor. The sparger 112 may be controlled to increase or decrease the production of the plurality of bubbles within the hydrate formation vessel 106. The gas 102 may be injected into the hydrate formation vessel 106 at any suitable flow rate, though larger flow rates are desirable to provide a continuous production of hydrates in the formation vessel 106. In some examples, an increase in flow rate of gas through sparger 112 may increase the formation of hydrates in the hydrate formation vessel 106. The hydrate formation vessel 106 may include a flowline 108 in fluid communication with the top of the hydrate formation vessel and the inlet manifold 104 for collecting recirculating the unused gas which is not captured to generate hydrates. In some examples, flowline 108 may include a pump to boost pressure of the gas therein to inject into manifold 104. The recirculated gas from the flowline 108 can be mixed with the incoming gas 102 in the inlet manifold 104 prior to being injected into the hydrate formation vessel 106 through the sparger 112.

The hydrate formation vessel 106 may include an internal chamber for subjecting bubbles from the sparger 112 and liquid comprising water (e.g., freshwater, seawater, etc.) in the hydrate formation vessel to an elevated pressure, where the hydrate formation vessel 106 can include a pressurizing subsystem (e.g., a compressor, a pressure cell, a piston, a pump, etc.), as well as additional component subsystems. In some examples, the system 100 can utilize, or otherwise build upon, existing subsea infrastructure for producing and transporting fluids. In some examples, the hydrate formation vessel 106 subjects the liquid and bubbles to a formation pressure, for example, falling within a range of 150 psi to 4500 psi, or more. In some cases, the pressure may be larger when the system 100 is present at or near the sea floor, depending on the depth. Example formation pressure may be from 150 psi to 200 psi, from 200 psi to 500 psi, from 500 psi to 1000 psi, from 1000 psi to 1500 psi, from 1500 psi to 2000 psi, from 2000 psi to 2500 psi, from 2500 psi to 3000 psi, from 3000 psi to 3500 psi, from 3500 psi to 4000 psi, or from 4000 psi to 4500 psi,. In some examples, the formation pressure is greater than 150 psi. In some examples, the formation pressure is greater than 4500 psi. In some examples, the hydrate formation vessel 106 is in thermal communication with a heat exchanger for cooling the liquid and/or maintaining the liquid at a hydrate formation temperature. In some examples, the hydrate formation temperature falls within a range from about −25° C. to about 25° C., such as from −25° C. to −20° C., from −20° C. to −15° C., from −15° C. to −10° C., from −10° C. to −5° C., from −5° C. to 0° C., from 0° C. to 5° C., from 5° C. to 10° C., from 10° C. to 15° C., from 15° C. to 20° C., or from 20° C. to 25° C. Temperatures of at or slightly above the freezing temperature of water may be used, for example, as such temperatures may limit or prevent water-ice from forming when formation of clathrate hydrates are desired. In some examples, the system 100 may be positioned at or near the seabed, where for example, the temperature is from about 2° C. to about 5° C.

In some examples, the system 100 includes an inlet valve and pump 110 for injecting the liquid into the hydrate formation vessel 106. In some examples, the liquid may be transported via a flowline from the surface to the hydrate formation vessel 106 positioned near the seabed. In any examples, the liquid or at least a portion of the liquid may be provided as unreacted liquid recaptured from the system. Such a configuration may advantageously allow for efficient use of the liquid as a resource for preparing CO₂ hydrates, similar to the use of recaptured gas. However, the inventors have surprisingly and unexpectedly found that use of recaptured liquid tends to provide for more efficient formation of hydrates. That is, when the liquid being used for hydrate formation has been recaptured from an unreacted portion of the liquid used previously in hydrate formation, the nucleation and growth of hydrates is faster than when the liquid has never been used for hydrate formation previously. This effect is sometimes referred to as a ‘memory effect’ in that the recaptured liquid may exhibit some characteristic relating to its previous use in forming hydrates which catalyze the formation of additional hydrates. Without wishing to be bound by any theory, the recaptured liquid may contain very small amounts of hydrates suspended in the liquid that may, in effect, act as seed crystals, and provide for improved nucleation and growth of additional hydrates under appropriate hydrate formation conditions (e.g., pressure, temperature, composition).

In some examples, the liquid may have a concentration of dissolved salts. For example, the liquid may include, but is not limited to, seawater, brackish water, fresh water, processed water, produced water, purified water, hypersaline water, brine, or water including an ion concentration in a range from 0% to 3.5% by weight, such as from 0% to 1%. In some examples, the liquid may have a pH value falling within a range of 5 to 9. It will be appreciated that the amount of the gas 102 dissolved or otherwise present in the water may control or impact the pH in some cases. In some cases, the amount of gas 102 dissolved or otherwise present in the water may correspond to a saturation amount. In some examples, unreacted liquid present in or extracted from the compaction chamber 122 may be returned to the hydrate formation vessel 106, such as via pump 110.

In some examples, the system 100 may be positioned at a subsurface or seabed location, remote from a land-based CO₂ generation source, and the CO₂ may be transported to the system 100. Such a configuration is schematically illustrated in FIG. 1B, which shows CO₂ generation source 150 positioned on land and captured CO₂ transported via pipeline 155 to system 100.

In some examples, the system 100, or components thereof, may be positioned on land or at a subsurface location adjacent to land and the clathrate hydrate produced in the hydrate formation vessel 106 may be transported, via a pipeline (e.g., as a slurry comprising clathrate hydrate, trapped gas, and unreacted water), to the seabed where clathrate hydrate plugs can be generated by compaction and packaged within the container. For example, the hydrate formation vessel 106 can be positioned on land and may be in fluid communication with a slurry pump 114 for transporting the clathrate hydrate slurry from the hydrate formation vessel 106 to an accumulation chamber 118 positioned internal to a containment chamber 124. In examples, the containment chamber 124 may be positioned on the seabed, but the containment chamber 124 may be optionally positioned on land or at the sea surface or elsewhere underwater. In some examples, unreacted liquid present in the accumulation chamber 118 may be returned to the hydrate formation vessel 106, such as via pump 110.

The slurry pump 114 can optionally be used to transport hydrate slurry from the hydrate formation vessel 106 to the accumulation chamber 118 for collecting the clathrate hydrate slurry, but other examples may use other systems which may sweep or otherwise induce transport of the clathrate hydrate slurry into the containment chamber. Although one accumulation chamber 118 is shown in FIG. 1A, examples are contemplated where multiple accumulation chambers are used or where no accumulation chamber is used.

In some examples, the rising bubbles generated within the hydrate formation vessel 106 may provide the driving force for transporting the hydrate slurry from the hydrate formation vessel 106 to the accumulation chamber 118. In some examples, the bubbles generated in the hydrate formation vessel 106 via the sparger 112 can be from 100 nm to 1 cm in diameter. In some examples, the bubbles may comprise a plurality of bubbles. The plurality of bubbles generated within the hydrate formation vessel 106 can be a range of different sizes, such as from 100 nm to 500 nm, from 500 nm to 1 μm, from 1 μm to 500 μm, from 500 μm to 1 mm, from 1 mm to 5 mm, or from 5 mm to 1 cm in diameter.

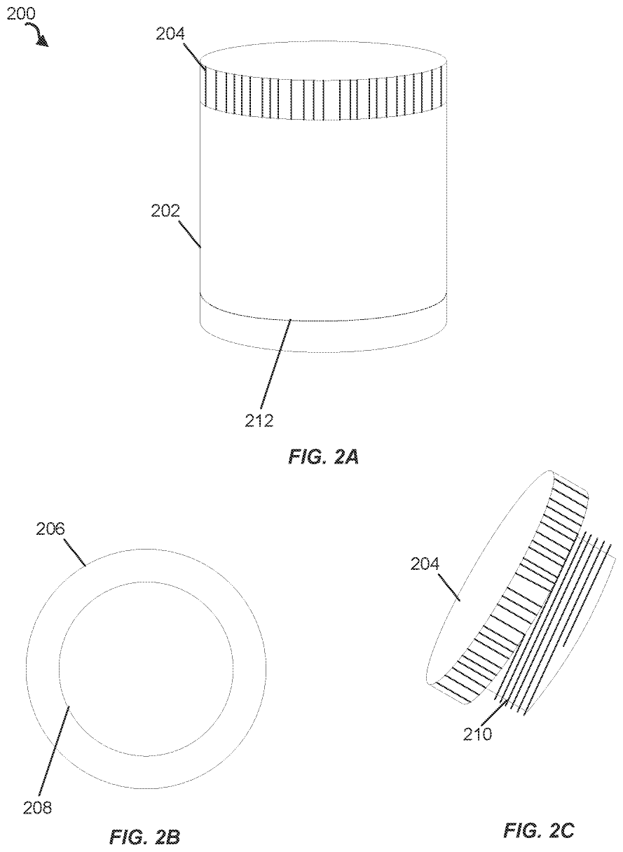

In some examples, the system 100 may include a compaction chamber 122 within containment chamber 124. The compaction chamber 122 can include a piston actuation mechanism 120 for compacting the hydrate slurry into a hydrate plug 128, but other examples are contemplated for compacting the hydrate slurry into a hydrate plug (e.g., a roll press). In some examples, the hydrate slurry may be compressed to generate a hydrate plug 128 that is greater than 80% clathrate hydrate. For example, the hydrate plug 128 may have a clathrate hydrate mass or volume component that greater than or about 80%, greater than or about 81%, greater than or about 82%, greater than or about 83%, greater than or about 84%, greater than or about 85%, greater than or about 85%, greater than or about 87%, greater than or about 88%, greater than or about 89%, greater than or about 90%, greater than or about 91%, greater than or about 92%, greater than or about 93%, greater than or about 94%, or greater than or about 95%. The hydrate plug 128 may be transported from the compaction chamber 122 into a sleeve receptacle 126 or other container. In some examples, as described in more detail in reference to FIG. 2A-2C, the container, in which the hydrate plug 128 can be disposed, can be transported from the containment chamber 124 and out of the system 100 via a trap door 130. In some examples, unreacted liquid present in or extracted from the compaction chamber 122 may be returned to the hydrate formation vessel 106, such as via pump 110 or pump 132.

In some examples, various components of the system 100 may be positioned at different locations to facilitate production and compaction of the generated hydrates. For example, as illustrated in FIG. 1C, the hydrate generation components of system 100, such as hydrate formation vessel 106 may be located at or adjacent to a land-based CO₂ generation source 150, and the generated hydrate slurry may be transported to the system containment chamber 124 at a remote subsurface location, such as via pipeline 155. Such a configuration may be useful for being able to control the conditions within hydrate formation vessel 106, to allow for routine maintenance within hydrate formation vessel 106, and/or to allow a single hydrate formation vessel 106 to provide hydrate slurry to a plurality of hydrate compaction and sealing units (e.g., including a containment chamber 124 and various components thereof) distributed at various subsurface locations. Further, during transport of a hydrate slurry, such as within pipeline 155, additional trapped gas and unreacted water can convert to additional solid clathrate hydrate, increasing production without requiring substantial additional inputs.

FIGS. 2A, 2B, and 2C provide schematic diagrams illustrating an example container 200 for storing the clathrate hydrate plug in accordance with some examples of the present disclosure.

FIG. 2A shows an example overview of the container body 202 and the lid 204 secured to the container body 202. The container can comprise a first portion and an independent second portion. The first portion may be the container body 202 that may have the hydrate plug 128 disposed into the container body 202. The second portion of the container can be a lid 204. The lid 204 for example, can be a screw lid, a push lid, a pressure sealable lid, or other suitable lids for providing a secure containment of material at high pressures and low temperatures.

FIG. 2B is a cross-sectional top-down view of an example of the container body 202. In some examples, the container body 202 may comprise two layers of a polymer and/or a composite. The first layer 206 may have a diameter that is greater than the diameter of the second layer 208. In some examples, the first layer 206 may have a length that is longer than the length of the second layer 208. FIG. 2C shows a schematic view of lid 204, showing threads 210 which may be used to seal, adapt, or join the lid to the container body 202.

In some examples, one or more surfaces of the container 200 may comprise a coating.

For example, the coating may be a superhydrophobic coating to prevent water molecules from interacting with the surface of the container 200. In some examples, the coating may be an anti-fouling coating to prevent degradation of the container 200 while on the seabed. In some examples, the container 200 may include two coatings wherein the first coating is on the second layer 208 and the second coating is on the outer surface of the first layer 206. In some examples, the inner coating may provide functional properties such as resistance to degradation by water and CO₂. In some examples, the second coating on the outer surface of the container body 202 may provide functional properties such as resistance to water, including saltwater, and marine organisms, such as antifouling paint, hydrophobic coatings, superhydrophobic coatings, superhydrophobic lubricant infused composite coatings, or the like. In some examples, the first and second coatings may be 0.1 nm to 1 mm thick, or thicker. For example, the coating can be 0.1 nm to 1 nm, from 1 nm to 10 nm, from 10 nm to 100 nm, from 100 nm to 1 μm, from 1 μm to 10 μm, from 10 μm to 100 μm, or from 100 μm to 1 mm.

In some examples, the space between the first layer 206 and the second layer 208 can allow for the expansion or compression of the container 200. In some examples, the material comprising the container 200 may have very low CO₂ permeability, a high tensile strength, shear strength, toughness (ductility), a high tear resistance, a high burst resistance, resistance to seawater degradation to withstand the immediate environment for which the container is disposed in. In some examples, the material may comprise a polymer or a composite including one or more of polyethylene terephthalate, polyurethane, high-density polyethylene, low-density polyethylene, ethylene propylene diene, ethylene propylene, ultra-high molecular weight polyethylene, perfluoroelastomer, polyether ether ketone, or polyetherimide. In some examples, the container 200 and hydrate plug within the container may have a combined density of greater than 1.00 g/cm³. In some examples the density is greater than 1.01 g/cm³, greater than 1.02 g/cm³, greater than 1.03 g/cm³, greater than 1.04 g/cm³, or greater than 1.05 g/cm³. In some examples, the container 200 is made of material that does not degrade in seawater for 1000 years. In some examples, 200 is made of material that does not photo-degrade in seawater for 1000 years, noting that very little light penetrates the ocean, below depths of 200 meters from the surface of water.

FIGS. 2A-2C provide just one example of a container and it will be appreciated that any other suitable containers may be used. In some examples, the container may include a sleeve type construction comprising the polymer or composite. For example, the sleeve container may have a flexible form to allow for expansion and/or contraction of the clathrate hydrate. In some examples, the sleeve may comprise one or more coatings on the internal surface of the sleeve and/or the outer surface of the sleeve. The internal coating may include properties such as resistance to water and CO₂. The outer coating may provide water resistance (including saltwater) and anti-fouling properties (e.g., superhydrophobic character).

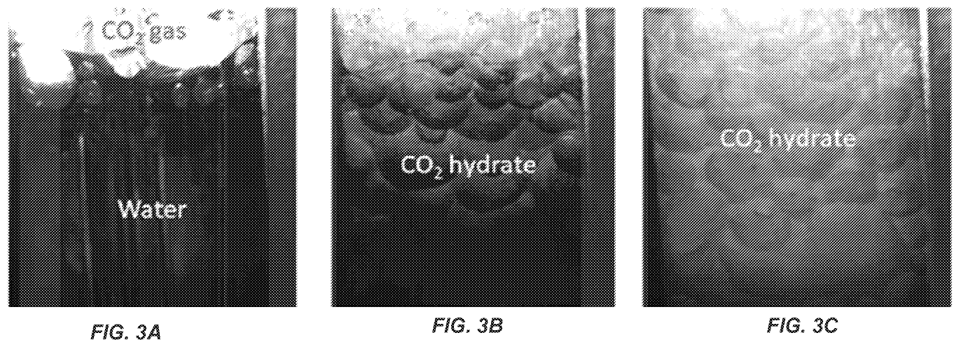

FIG. 3A provides a photograph of CO₂ bubbling prior to hydrate formation (t=0 min.), in accordance with an example of the present invention. For example, the CO₂ gas can be injected into a hydrate formation vessel through a sparger to generate a plurality of bubbles. The plurality of bubbles can coalesce with CO₂ gas at the CO₂ gas-water interface.

FIG. 3B shows a photograph of CO₂ hydrate growth and accumulation (t=2 min). In some examples, the clathrate hydrate may form in the water below the gas-water interface and the bubbles may push the clathrate hydrate up to or above the gas-water interface.

FIG. 3C shows a photograph of CO₂ clathrate hydrate growth after 5 minutes of bubbling time. In some examples, the hydrate formation vessel may fill with formed clathrate hydrate before the clathrate hydrate may be pumped to the compaction chamber. In other examples, the hydrate may be removed from the hydrate formation vessel in a simultaneous manner as the hydrate is formed to prevent filling or overfilling of the hydrate formation vessel with hydrate.

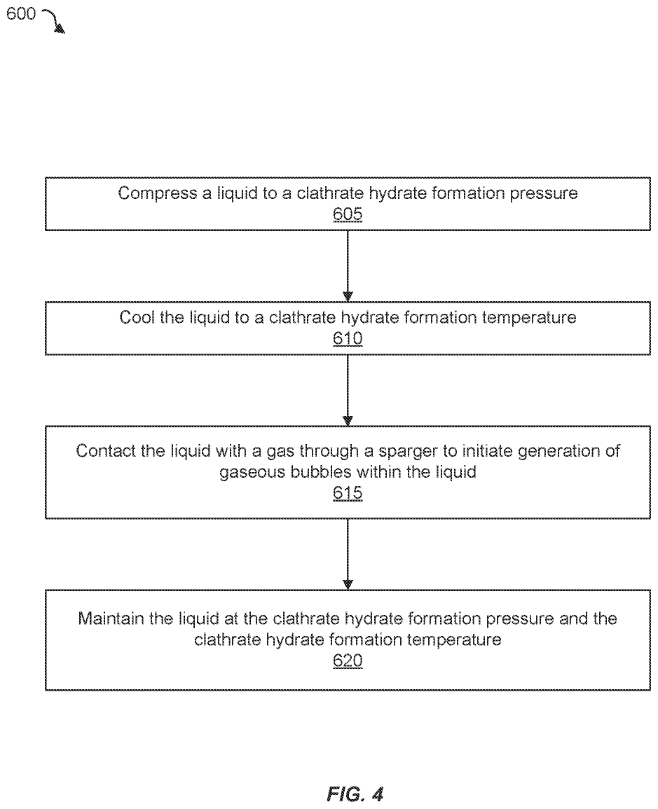

FIG. 4 provides an overview of an example method for forming CO₂ clathrate hydrates, in accordance with some examples of the present disclosure. At block 405, a liquid is compressed to a clathrate hydrate formation pressure. For example, the liquid may comprise water and the formation pressure may be in excess of 150 psi or 200 psi. The water may be for example, a water with a salinity from 0 to 35 g/L.

At block 410, the liquid is cooled to a clathrate hydrate formation temperature. The formation temperature may be close to or about 0° C., such as from −5° C. to 5° C. It may be useful for the formation temperature to be greater than the freezing temperature of water, so as to limit or prevent formation of water-ice and allow preferential formation of a clathrate hydrate. The order of blocks 410 and 405 may be reversed, such as the liquid is cooled and then pressurized.

Alternatively, blocks 405 and 410 may be combined, such as the liquid is cooled and pressurized simultaneously. In some examples, block 410 may be averted in that the liquid injected into the hydrate formation vessel may be at the desired temperature for hydrate formation to occur. In some examples, block 405 may be averted in that the liquid in the hydrate formation vessel may be at the desired pressure for hydrate formation to occur (e.g., when the hydrate formation vessel is present at the seabed).

At block 415, the liquid is contacted with a CO₂ gas, such as through a sparger, to initiate generation of gaseous bubbles within the hydrate formation vessel. Excess gas may be collected at the top of the hydrate formation vessel and recirculated to the sparger.

At block 420, the liquid is maintained as a formation temperature and pressure, such as for an amount of time sufficient for formation and growth of the clathrate hydrate. In some examples, the system can be operated in a batch process wherein the formation of the clathrate hydrate occurs in intermittent intervals as gas is sparged through the liquid and clathrate hydrates form and accumulate within the hydrate formation vessel. In some examples, the system can be operated in a continuous process wherein the liquid is maintained at the formation temperature and pressure continuously and the gas is injected into the hydrate formation vessel at a continuous flow rate to continually make clathrate hydrates, which can be removed continuously and/or periodically.

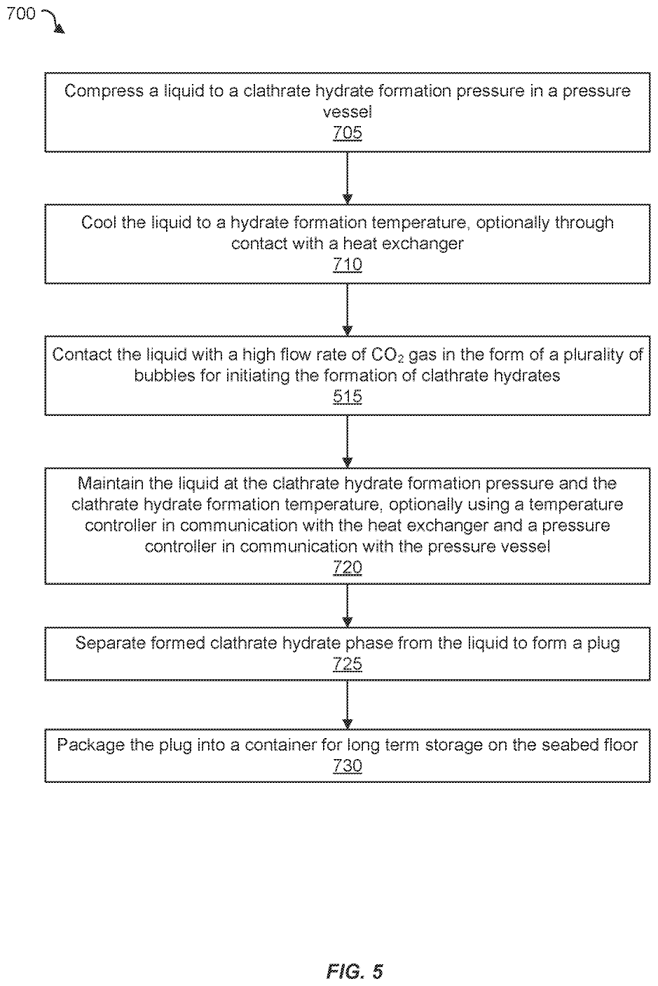

FIG. 5 provides an overview of an example method 500 for forming, compacting, and sealing CO₂ clathrate hydrates into a container, in accordance with some examples of the present disclosure. At block 505 a liquid is compressed to a clathrate hydrate formation pressure in a hydrate formation vessel, which may be a pressure vessel. In some examples, the hydrate formation vessel may include a bubble column reactor or airlift reactor and the pressure may be in excess of 200 psi or up to 4500 psi, or more. The compression of the liquid may occur via the use of one or more pumps, pressure sensors, pressure controllers, or the like, or may naturally occur by positioning the hydrate formation vessel at the sea floor.

At block 510, the liquid is cooled to a hydrate formation temperature through contact with a heat exchanger. In some examples, the heat exchanger can include a cooling jacket positioned around the hydrate formation vessel. For example, the cooling jacket can include a cooling fluid circulating through the cooling jacket. In some examples, the liquid is injected into the hydrate formation vessel at a temperature conducive to hydrate formation. For example, the system can be positioned at the seabed and an inlet valve and pump may be manipulated to allow injection of seawater from the surroundings. For example, the temperature of water at the seabed may be between 0° C. to 5° C.

At block 515, the liquid is contacted with a high flow rate of CO₂ gas in the form of a plurality of bubbles for initiating the formation of clathrate hydrates. In some examples, the flow rate of CO₂ into the hydrate formation vessel may provide conditions for rapid generation of CO₂ clathrate hydrates. In some examples, the hydrate formation vessel may include a flowline for recirculating CO₂ gas that is unutilized through a first pass through the hydrate formation vessel.

At block 520, the liquid is maintained at a clathrate hydrate formation pressure and temperature for a sufficient time for growth of the clathrate hydrate, optionally using a temperature controller and a pressure controller in communication with the hydrate formation vessel. In some cases, a temperature sensor or a pressure sensor may be positioned in thermal or fluid communication with the hydrate formation vessel to allow for determination of the temperature and/or pressure therein in real-time. In some examples, the system can be operated in a batch process wherein the formation of the clathrate hydrate occurs in intermittent intervals. For example, the hydrate formation vessel may be injected with a gas for a time sufficient for generating a clathrate hydrate, such as for 20 minutes to 24 hours. In some examples, the system can be operated in a continuous process wherein the liquid is continuously injected and maintained at the formation temperature and pressure continuously and the gas is injected into the hydrate formation vessel at a continuous flow rate to continually make clathrate hydrates.

At block 525, the clathrate hydrate is separated from the liquid phase to form a plug. In some examples, the hydrate formation vessel may be in fluid communication with a slurry pump to transport the clathrate hydrate from the hydrate formation vessel to an accumulation chamber for temporary storage of the clathrate hydrate slurry. For example, the clathrate hydrate slurry may be accumulated in the accumulation chamber while a compaction chamber is simultaneously compacting other clathrate hydrates into a plug. The compaction chamber may compact the slurry material into a hydrate plug in a continuous or batch process. In some examples, the compaction chamber may include a piston actuation mechanism for compacting the slurry into a plug. In some examples, the compaction chamber may include a roll press for compacting the slurry into a plug. The plug can, for example, comprise the clathrate hydrate in an amount of at least 80 wt. % clathrate hydrate. For example, the plug can comprise clathrate hydrate in an amount of at least 81 wt. %, at least 83 wt. %, at least 84 wt. %, at least 85 wt. %, at least 86 wt. %, at least 87 wt. %, at least 88 wt. %, at least 89 wt. %, or at least 90 wt. % of the plug mass.

In some examples, the hydrate formation vessel may be in fluid communication with the compaction chamber and may allow for the simultaneous compaction of clathrate hydrate while new clathrate hydrate is generated. In some examples, the hydrate formation vessel may be in fluid communication with the compaction chamber and the clathrate hydrate may be injected into the compaction chamber via a rotating mechanism to push clathrate hydrate slurry into the compaction chamber.

At block 530, the clathrate hydrate plug is packaged into a container for long-term storage. In some examples, the container may be a solid container with a lid that can be fastened to the container body via a screw-on, pressure sealable, or locking mechanism. For example, the container may comprise a polymer or composite such as including one or more of polyethylene terephthalate, polyurethane, high-density polyethylene, low-density polyethylene, ethylene propylene diene, ethylene propylene, ultra-high molecular weight polyethylene, perfluoroelastomer, polyether ether ketone, or polyetherimide, or combinations thereof. In some examples, the container and the plug may have a combined density greater than water or seawater, such as greater than or about 1.01 g/cm³, greater than or about 1.02 g/cm³, greater than or about 1.03 g/cm³, greater than or about 1.04 g/cm³, or greater than or about 1.05 g/cm³. In some examples, the system may include a trapdoor that can be opened for disposing the container onto the seabed. In some examples, the system may include a conveyer type system for disposing the container some distance from the system.

The invention may be further understood by the following non-limiting examples.

### Example 1: Formation of CO₂ Clathrate Hydrate Via Bubbling in A Bubble Column Reactor

Gas hydrate formation has several applications including CO₂ sequestration, desalination, gas transport etc. Formation of CO₂ hydrates is often constrained by very high induction (wait) times and slow growth times, which necessitates the use of promotion and enhancement methods for generating hydrates. Described herein, the formation techniques used incorporate an increased flow rate of the CO₂ gas within the bubble reactor column to rapidly generate clathrate hydrates. In general, the increased flowrate and generation of bubbles within the reaction vessel may be useful for generating clathrate hydrates.

Clathrate hydrates are ice-like solids consisting of a lattice of hydrogen-bonded water molecules encapsulating a guest molecule. Gas hydrates (Methane, Carbon dioxide) form under medium pressure, low-temperature conditions. Formation involves nucleation of the first ‘cluster’ of stable hydrate molecules followed by growth. Nucleation of hydrates is generally characterized by very long induction/wait times, typically ranging from hours to days, especially in a quiescent medium. Growth of hydrates is a bigger challenge and is limited by mass transfer and heat transfer considerations. All these challenges can together be addressed via nucleation and growth-promoting techniques such as the use of high flow rates of the gas into the sparger and generating a plurality of bubbles ranging in size from 100 nm to 1 cm. This example describes how rapid formation of clathrate hydrate can be conducted using the system and methods described herein.

Experiments were conducted using an experimental setup comprising a CO₂ cylinder in fluid communication with a reaction vessel. The reaction vessel included a thermocouple positioned at the top of the reaction vessel. A bendable tube is positioned internal to the reaction vessel. In fluid communication with the bendable tube is a sparger positioned at the bottom of the reaction vessel for generating a plurality of bubbles within the reaction vessel. The reaction vessel was filled with 300 ml of water and was bubbled with a flow rate of about 5.9 standard liters per minute CO₂. The experimental setup converted water and gas to clathrate hydrates in about 5 minutes. The reaction vessel was held under a pressure of 400 psi and at a temperature of 4° C. Theses result clearly highlight the influence of CO₂ flow rate and generation of a plurality of bubbles on CO₂ clathrate hydrate formation.

Without being bound by any theory, results of in house experiments can be used to estimate the hydrate formation rate via the use of the systems and methods describe herein. The best results obtained so far imply that the method described herein has a CO₂ sequestration rate of 2500 gm/hr/liter (reactor volume) of CO₂. Results indicate a significant (8 times) increase in the CO₂ sequestration rate compared to the highest reported value of CO₂ sequestration using CO₂ hydrates. The results indicate that the current 650 ml reaction vessel can synthesize sufficient hydrates to sequester about 14 tons of CO₂ per year. These findings represent significant improvements when compared to modern sequestration techniques employed today.

### Example 2: Ultrafast, Chemical Promoter-Free, CO₂ Hydrate Slurry Formation for Carbon Sequestration

This example describes ultrafast formation of CO₂ hydrate slurry without the use of any chemical promoters. This is achieved via magnesium-based promotion of hydrate formation in a bubble column reactor. The gas consumption rate for sequestration as hydrate slurry (sequestration rate) and slurry composition are quantified versus various parameters including thermodynamic (pressure, temperature), CO₂ flow-related parameters (flow rate and duration), water composition and magnesium quantity. the maximum sequestration rate is 2464 g/hr/l (of reactor volume) which is >8 times higher than the fastest reported rate. This discovery enables several hydrates-related applications like CO₂sequestration, gas separation and desalination, which were hindered by the notoriously slow formation of hydrates.

There is broad consensus among the global scientific community that gigascale carbon capture and sequestration (CCS) will be imperative to mitigate the negative impacts of climate change in view of the slow pace of decarbonization. CCS targets are as high as 10 Gigatons/yr. In contrast, existing global CCS capacity in 2020 was <50 Megatons/yr. Large opportunities exist for an array of CCS technologies, to cater to various geographic regions. Commensurate to these opportunities is the expanding research into frontier areas such as direct air capture, oceanwater capture etc.

This example describes on an alternate approach for sequestration of carbon dioxide (CO₂). The state-of-the-art sequestration approach is CO₂ injection in reservoirs. However, there are very limited reservoirs which have permits for long-term sequestration. There exist only 2 Class VI wells in the US currently, which allow injection for long-term sequestration. Reasons for slow permitting include the need to assess risks of CO₂ leakage and seismic activity associated with injection. Notably, despite more than 70 pending applications to the Environmental Protection Agency (EPA) as of the time of filing of the instant application, no permits have been issued since 2020, highlighting the challenges and risk assessments needed for permitting. Furthermore, there are extensive requirements on monitoring, which drives up costs as large areas need to be monitored, sometime for decades. Importantly, many regions do not have appropriate geology for CO₂ sequestration, which will pose additional challenges. While there are many other reservoir injection projects, they are tied to enhanced oil recovery.

One alternative to reservoir injection is storage in saline aquifers, or CO₂ mineralization in geological sites of rocks like basalt etc. However, the area footprint of mineralization projects is much larger than injection projects, which leads to higher costs. Microbial CO₂ sequestration is a low energy intensive and environmentally friendly approach, however, the efficiency of microbial CO₂ fixation is low. Alternatives to sequestration include embedding CO₂ in concrete, chemicals, etc. While these are very promising, such approaches by themselves will not be able to address gigascale sequestration requirements. Overall, it is clear that additional options for sequestration need to be urgently added to the basket of available solutions.

This Example outlines a disruptive approach to the synthesis of CO₂ hydrates for sequestration. CO₂ hydrates are ice-like crystalline materials, synthesized from CO₂ and water at medium-pressures (>400 psi) and low temperatures (<5° C.); these conditions are prevalent in large parts of oceans worldwide. Structurally, CO₂ hydrates include a cage of water molecules which trap a CO₂ molecule. On average, 6 water molecules trap 1 molecule of CO₂. 1 kg of solid CO₂ hydrate can sequester up to 290 grams of CO₂ (e.g., 150 liters of CO₂ at 25° C. & 1 atm). Importantly, CO₂ hydrates are denser than seawater (density: 1040-1160 kg/m³).

Hydrates-based CO₂ sequestration in subsea porous media under marine sediments has been proposed. Alternatively, hydrates could be stored on the seabed with the use of appropriate sealing materials to prevent dissociation of hydrates in seawater, as seen in field tests. Hydrates have another important value proposition in CCS since they can lower overall CCS costs by reducing the need for purification of CO₂. The current practice of reservoir injection requires CO₂ purity levels >95%. Purification of captured CO₂ is a big contributor to overall costs and resources associated with CCS. Alternatively, hydrates can be formed from flowstreams with CO₂ purity levels of 40-60%, which significantly lowers the cost of purification, thereby increasing the overall economic viability of CCS.

A technical challenge to any hydrates-based approach is the very slow formation rate of hydrates. Gas hydrates (CO₂, methane) can take hours to days to nucleate in the absence of external promotion techniques. Chemical promotion and mechanical agitation are commonly used to initiate nucleation. However, even post-nucleation, the growth rate is limited by multiple factors. Gas diffusion through the already formed hydrate shell/layer slows down further growth. Heat transfer considerations also influence the growth rate, if the heat released from hydrate formation cannot be removed. Solutions to enhance growth include the use of kinetic and thermodynamic promoters, mechanical agitation, electronucleation, etc. However, using such approaches increases the complexity of operations; besides the use of chemicals is undesirable.

Even with the use of the above techniques hydrate formation rates are very low. Table 1 summarizes examples with the highest reported formation rates. These studies are compared using a metric of gas consumption rate per unit volume (of reactor). This is the rate (unit: g/hr/liter) at which CO₂ can be sequestered, and is termed as sequestration rate (\dot{m}_{S}) in this study. The studies which reports the fastest sequestration report the use of packing columns (high area to volume ratio) and a surfactant [24]-[26]. The highest sequestration rate was 303.6 g/hr/l for SSP-2 metallic packing with the use of 1 wt % SDS solution. Most other studies report far lower sequestration rates.

TABLE 1
Compilation of studies reporting CO2 hydrate formation in advanced reactors.

| | | Inlet Mixture | Sequestration | |
|---|---|---|---|---|
| Press., | Experimental | and Promoter | Rate | |
| Temp. | setup | Used | (\dot{m}_{S} in g/hr/L) | Highlights |
| 12 MPa, | Continuous Jet | CO₂ (l) and H₂O; | 0.64 g/hr | Tubular paste-like hydrate |
| 276.45 K | co-flow hydrate | no promoters | | plumes sink in ocean as |
| | reactor | | | CO₂ dissolves |
| 3.5 MPa, | Water spray | Oscillating CO₂ | 22 | Larger nozzle atomizing |
| 275.65 K | in ~4.3 L reactor | supply; no | | angle is more favorable for |
| | (173 mm dia., | promoters | | hydrate formation |
| | 568 mm height) | | | |
| 5 MPa; | Horizontal | CO₂/CH₄ | 231.73 | High liquid-gas contact |
| 274 K | packed bed | mixtures; | | area and tryptophan |
| | reactor (1 L) with | tryptophan and | | critical to improve |
| | Cu foams | cyclopentane | | formation kinetics |
| 3 MPa; | SSP-2 metallic | Pure CO₂; | 303.6 | Packing with high |
| 274.65 K | packing used in | 1 wt % SDS | | area/volume ratio |
| | 0.4 L reactor | | | improves hydrate kinetics |
| 3.5 MPa, | Magnetic stirrer | Pure CO₂; | 14.43 | Graphite nanoparticles |
| 277.15 K | (at 300 rpm) in | nanofluid with | | cause 12.8% increase in |
| | 0.5 L reactor | 0.4% graphite | | max CO₂ consumption |
| | | nanoparticles | | |
| 3.5 MPa; | Mechanical | Pure CO₂; 5 wt % | 55.4 | Decylamine aqueous |
| 274.55 K | stirrer (at 600 | Decylamine | | solution shows best kinetic |
| | rpm) in 0.3 L | | | performance |
| | reactor | | | |
| 2.5 MPa, | Mechanical | CO₂/N₂ mixtures; | 0.35 | Mechanical agitation |
| 273.7 K | stirrer with | THF as promoter | | consumes significant |
| | inbuilt CO₂ | | | power |
| | recirculation | | | |
| | system (1.9 L) | | | |
| 7.5 MPa; | Magnetic stirrer | CO₂/N₂, CO₂/H₂; | 58.03 | CO₂ separation from |
| 273.7 K | in 0.323 L reactor | No promoters | | CO₂/N₂ and CO₂/H₂ |
| | | | | mixtures deemed viable. |
| 3 MPa; | Bubble Column | CO₂/H₂, pure | 0.6 | Gas bubbles form hydrate |
| 274.15- | Reactor of 40 L | CO₂; TBAB as | | shells that coalesce to |
| 281.26 K | capacity (.1x.1x4 | promoter | | form hydrate slurry. |
| | m) | | | Optimal bubble size is 50 |
| | | | | μm. |
| 3.55 & | Bubble Column | Pure CO₂; no | 2464.08 (This | High flow rates, amount of |
| 2.85 MPa; | Reactor (0.65 L: | chemical | Example) | Mg, and increase in |
| 2.6 ± 0.8° C. | 63.5 mm ID, | promoter used, | | pressure, lead to higher |
| | 152 mm depth) | Mg plate | | sequestration rate |

Mechanical agitation using magnetic or mechanical stirring is useful for enhancing hydrate formation; however mechanical agitation consumes significant power, which makes implementation challenging. Nanofluid made from graphite nanoparticles is useful for improving hydrate formation kinetics and max CO₂ uptake. The effect of chemicals like decylamine, amylamine, and methylamine on hydrate formation and dissociation kinetics has been evaluated, and 5 wt % decylamine is found to show the best results among the cases studied. A continuous jet co-flow reactor was used to conduct field tests by deploying hydrate plumes into the ocean at 1200 m depth (˜12 MPa). The plumes were observed to sink while the CO₂ would slowly dissociate into the ocean reducing the pH. A water-spray apparatus with oscillating CO₂ supply was used to enhance hydrate growth and a larger atomizing angle was observed to be more favourable for hydrate formation. A bubble column reactor with 40 L capacity has also been used for CO₂ hydrate formation. It was observed that hydrate would form on the surface of the bubble forming a hydrate shell. These shells would coalesce to eventually form hydrate slurry, but the sequestration rate was significantly lower than that observed in metallic packing. It is noted that most prior studies used chemical promoters, such as SDS, tryptophan, THF, TBAB, cyclopentane, etc., to enhance hydrate formation kinetics; with the best result observed with 1 wt % SDS. While some of these promoters are bio-friendly (like tryptophan), the use of chemical promoters is often undesirable as they increase cost, increase design complexity, reduce CO₂ removal from a life-cycle analysis standpoint, have health risks (e.g., carcinogens) and reduce overall sustainability of the process. This highlights the importance of developing a sustainable and bio-friendly approach by using a chemicals-free method to convert CO₂ into CO₂ hydrates.

In the results described in this example, a maximum sequestration rate of ˜2.5 kg/hr/liter has been observed, which is over 8 times higher than state of art. This finding is even more significant considering that no chemical promoter, mechanical agitation, material for packing column, or electric fields were used. This study leverages two recent discoveries. The first involves a discovery of magnesium as a nucleation promoter; in this study, it was found that magnesium is useful for rapid formation (beyond nucleation). Secondly, high flow rate sparging of CO₂ is employed, which increases hydrate formation via enhanced mass and heat diffusion and disruption of existing hydrate shells. Developed modelling framework used to predict hydrate formation in bubble column reactors shows that hydrate formation rates will increase with CO₂ flow rates. In addition to measuring the growth rate, the conversion fraction of CO₂ into hydrates is estimated, as it is a useful parameter for determining the utility of recirculation.

Experimental Methods. CO₂ gas was bubbled into a stainless-steel reactor (inner diameter: 6.35 cm, depth: 15 cm) housed inside an environmental chamber used to maintain temperature of the system. The reactor contained 200 ml DI water and a magnesium alloy (AZ31) plate of size 10.16 cm×1.27 cm. Experiments were conducted at a reactor setpoint temperature T_{c}=2.6±0.8° C. The setpoint was achieved by setting the temperature of environmental chamber, where the reactor is housed, to 1° C. The reactor was purged of air by bubbling CO₂ at a flowrate of 0.8 slpm (at atmospheric pressure) for 5 minutes. Next, the reactor was pressurized at 60 psi/min till the reactor pressure (P_{R}) reached desired pressure setpoint (Pₛₑₜ). Hydrates formed towards the end of the pressurization stage itself; this is consistent with the ultrafast nucleation (due to magnesium) reported previously. Therefore, in this study the formation time (t_{f}) was estimated from the instant when reactor pressure and temperature reached hydrate stability zone. Pressurization stage was followed by continuous flow at constant pressure (P_{R}=Pₛₑₜ=400 or 500 psig) maintained using a back-pressure regulator, and at a constant flow rate attained by a mass flow controller (FMA 5523A).

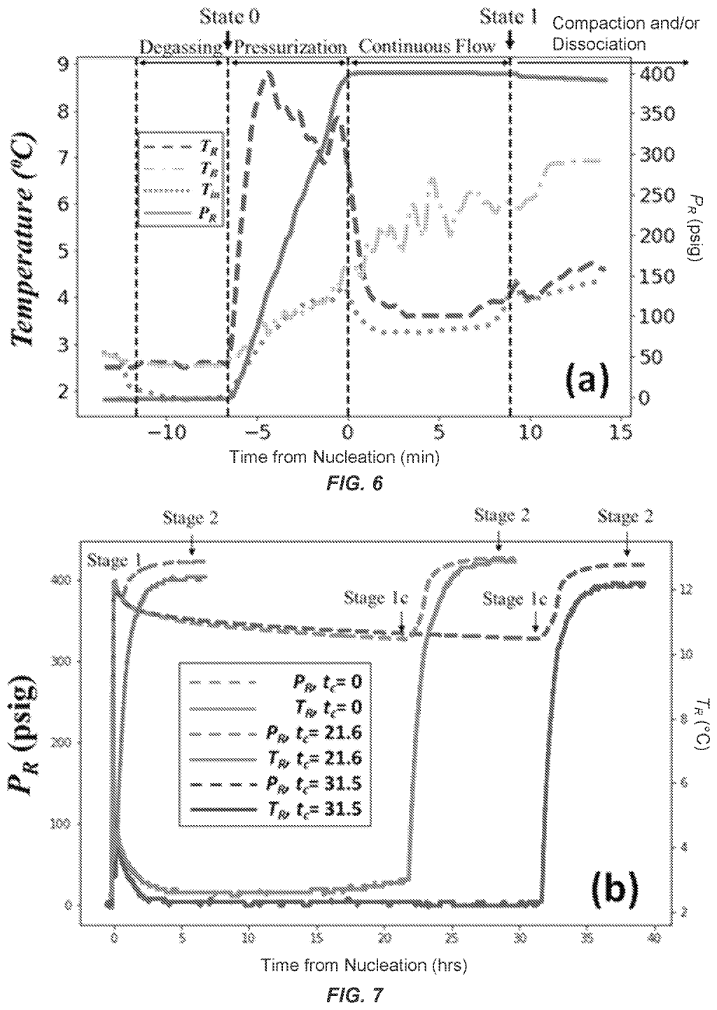

During continuous flow, bubbles entering the reactor rise and stick to existing hydrates. The existing hydrate grows a film on the attached bubble forming a hydrate shell with gas trapped inside it, as also observed in other studies. Incoming gas slowly forces these shells to coalesce with the rest, building up a slurry of hydrate-gas-water. Volume of this slurry is greater than the initial volume of water (FIG. 8, top row); the volume rise can be measured from the glass window. Temperatures are measured at three locations: gas at inlet of the reactor (Tᵢₙ), at the interface of water and gas inside the reactor (T_{B}), and the gas in the headspace inside reactor above the water level (T_{R}) (FIG. 8, top row). The inlet and outlet of reactor are closed at end of continuous flow (State 1), wherein T_{B1} is the temperature of the hydrate slurry, T_{R1} is the temperature of the gas in the headspace above the hydrate slurry, and P_{R1} is the reactor pressure. Detailed variations of temperature and pressure during degassing, pressurization, continuous flow, and compaction are provided in FIG. 6.

In two experiments, the reactor was left closed for a few hours to compact the hydrate slurry. Hydrates were observed to form along the walls of the reactor during this stage. The corresponding volume increase was neglected and the volume of hydrate slurry column in compacted stage was considered to be the same prior to compaction. This causes a significant decrease in pressure as the gas converts to hydrate and the temperature of reactor stabilizes. Compaction times (t_{c}) of 21.6 hrs and 31.5 hrs were used in two experiments in this study.

Next, the temperature was increased to 12.1±0.2° C. by changing the environmental chamber temperature to 11° C., which causes a thermal stimulation induced hydrate dissociation leading to a pressure rise. The reactor was left for 8+ hours to reach thermodynamic equilibrium. At the end of this step (state 2), it can be assumed that the water is saturated with CO₂ and is in thermal and mass equilibrium with the gas above. The reactor is then depressurized to end the experiment. Water volume was confirmed to be unchanged at the end of the experiment.

Analysis Framework. Here, a novel analytical framework is described to estimate the formation rate and conversion fraction in the experiments. It is based on using measurements of pressure, temperature, and volume change to estimate distribution of CO₂ in the reactor after continuous flow is stopped. CO₂ in the reactor can then exist either as gas in the headspace (m_{C,ga}), absorbed by water as hydrates or dissolved gas (m_{C,hw}), or as unreacted trapped gas in the slurry (m_{C,gt}); the framework can quantify this distribution. The volume rise of hydrate slurry column is used to obtain the change in volume of headspace in the reactor across states 1 and 2. Reactor pressure, temperature and volume of headspace at states 1 and 2 can be used to obtain the mass of CO₂ in headspace at state 1 and 2 (m_{c,ga1} and m_{c,ga2}). Henry's law can be used to estimate the amount of CO₂ dissolved in water at state 2 (m_{c,w2}), assuming complete solubility. Summing the two masses of CO₂ in state 2 gives the total mass of CO₂ in reactor (m_{c,T}) as no hydrates are present at state 2. The sequestration rate (\dot{m}_{S}) can be obtained by equation 1 based on the formation time (t_{f}) and reactor volume (V_{R}).

$${\dot{m}}_{S} = \frac{{m}_{C , ga 2} + {m}_{C , w 2} - {m}_{C , ga 1}}{{t}_{f} {V}_{R}} \qquad ( 1 )$$

The composition of slurry is estimated by dividing the total volume of slurry (Vs) into volume fraction of unused water (Y_{w}), volume fraction of hydrate (Yₕ), and volume fraction of trapped gas inside hydrate slurry (Y_{gt}). The unknown volume fractions can be evaluated by equating the total mass of H₂O (m_{w,T}) and total mass of system (CO₂+H₂O, i.e., m_{C,T}+m_{w,T}) in states 1 and 2 (equations 2 and 3). The total mass of H₂O is split into mass of unused water (molecular weight M_{w}) and the mass of H₂O in the form of hydrates (molecular weight Mₕ) as depicted in equation 2. A hydration number (ηₕ) of 6 and hydrate density (ρₕ) of 1100±60 kg/m³ is considered. The volume fractions along with the density of water (ρ_{w}), hydrate (ρₕ) and trapped gas (ρ_{gt}, obtained from compressibility equation at temperature T_{B1}) can be used to evaluate the mass contribution of individual components of slurry to the total mass of system (CO₂+H₂O) in state 1. The sum of mass of slurry and the mass of CO₂ in headspace (m_{c,ga1}) would be equal to the total mass in state 1 (equation 3). Once volume fractions are evaluated, the mass distribution of CO₂ and water in various phases can be obtained. Further details of this analytical framework and detailed analysis of the composition of slurry is provided in the supplementary information.

$${m}_{w , T} = {ρ}_{w} {Y}_{w} {V}_{S} + {ρ}_{h} {Y}_{h} {V}_{S} {M}_{w} {η}_{h} / {M}_{h} \qquad ( 2 )$$

$${m}_{C , T} + {m}_{w , T} = {m}_{C , ga 1} + {Y}_{w} {∇}_{S} {ρ}_{w} + {Y}_{h} {∇}_{S} {ρ}_{h} + {Y}_{gt} {∇}_{S} {ρ}_{gt} \qquad ( 3 )$$

The conversion fraction was evaluated by the amount of CO₂ sequestered in the hydrate slurry and the inlet mass flow rate (\dot{m}ᵢₙ) of CO₂ provided to the system during formation time of t_{f} (equation 4).

$$\% Conversion = \frac{{m}_{C , ga 2} + {m}_{C , w 2} - {m}_{C , ga 1}}{{\dot{m}}_{in} {t}_{f}} \times 100 \qquad ( 4 )$$

TABLE 2
Compilation of all experiments (conducted at Pₛₑₜ = 398 ±
2 psig and T_{R} = 2.6 ± 0.8° C. unless otherwise noted) in this study.

| | | | | | Volume of | | |
|---|---|---|---|---|---|---|---|
| | tₜₒₜ | \dot{m}ᵢₙ | m_{C, S} | \dot{m}_{gcr, S} | slurry | % | |
| Parameter | (min) | (slpm) | (g) | (g/hr/lit) | (V_{S}/V_{R}) | Conversion | ρ_{S}/ρ_{w} |
| \dot{m}ᵢₙ, tₜₒₜ | 15.5 | 10.82 ± 0.8 | 29.5 | 302.16 | 0.62 | 15.6 | 0.56 |
| tₜₒₜ | 14 | 10.69 ± 0.55 | 24.4 | 305.65 | 0.54 | 16.0 | 0.63 |
| t_{c} | 14 | 10.75 ± 0.32 | 24.1 | 301.63 | 0.55 | 15.7 | 0.61 |
| t_{c} | 14 | 10.68 ± 0.63 | 24.9 | 310.65 | 0.56 | 16.2 | 0.61 |
| tₜₒₜ | 13 | 10.74 ± 0.55 | 21.9 | 309.51 | 0.50 | 16.1 | 0.68 |
| tₜₒₜ | 12 | 10.77 ± 0.48 | 17.4 | 302.75 | 0.41 | 15.7 | 0.80 |
| \dot{m}ᵢₙ | 15.5 | 8.13 ± 0.59 | 27.0 | 267.36 | 0.58 | 18.4 | 0.59 |
| \dot{m}ᵢₙ | 15.5 | 4.47 ± 0.62 | 15.8 | 170.77 | 0.39 | 21.3 | 0.85 |
| \dot{m}ᵢₙ | 15.5 | 3.49 ± 1.40 | 15.1 | 161.94 | 0.39 | 25.9 | 0.84 |
| 6xMg amount | 14 | 10.73 ± 0.51 | 29.7 | 376.08 | 0.6 | 19.6 | 0.58 |
| Saltwater | 160 | 10.64 ± 0.43 | 23.0 | 13.71 | 0.36 | 0.7 | 0.95 |
| Tapwater | 14 | 10.63 ± 0.61 | 27.9 | 343.91 | 0.60 | 18.1 | 0.58 |
| Pₛₑₜ = 500 psig, | 15.25 | 10.30 ± 2.84 | 33.8 | 2464.08 | 0.61 | — | 0.59 |
| T_{R} = 2.2° C. | (t_{f} = 1.25) | | | | | | |

Results and Discussions. Hydrate formation rate increases at lower temperatures and higher pressures. However, constraints on the P-T window arise from the need to prevent ice formation or liquid CO₂ formation. Accordingly, the most aggressive thermodynamic conditions for hydrate formation in this study were 500 psig and 2.2° C. Under these conditions, magnesium triggered hydrate formation immediately after contacting the water (with CO₂ bubbling). Contact was initiated by dropping a magnesium plate upon reaching the set P, T conditions (using a magnet-based release arrangement). 33.8 grams of CO₂ was consumed in the slurry in the next 75 seconds. The corresponding gas sequestration rate was 2464 g/hr/l (Table 2), which is over 8 times higher than the highest sequestration rate of CO₂ hydrates of 303 g/hr/l in prior studies. This order of magnitude enhancement is the result of magnesium-based promotion, coupled with the benefits of gas flow, and a high water-gas-hydrate interfacial area for the given reactor size. Previous studies examined only the nucleation-promotion aspect of magnesium; this study quantifies the benefits of magnesium for overall hydrate formation. It is highlighted that magnesium is a valuable enabler of this concept, as zero or very sluggish/delayed formation was observed in the absence of magnesium. Notably, the hydrate formation rate at 500 psi was 8× higher than similar experiments conducted at 400 psi (Table 2). Further experiments and a parametric study were done at 400 psi, owing to significant ease in experimentation.

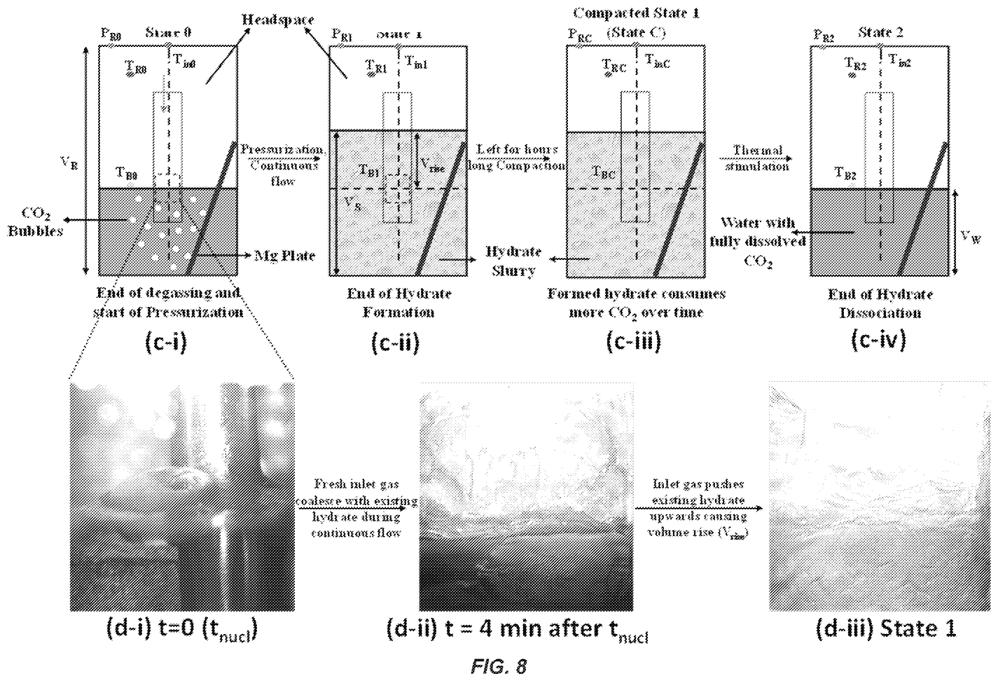

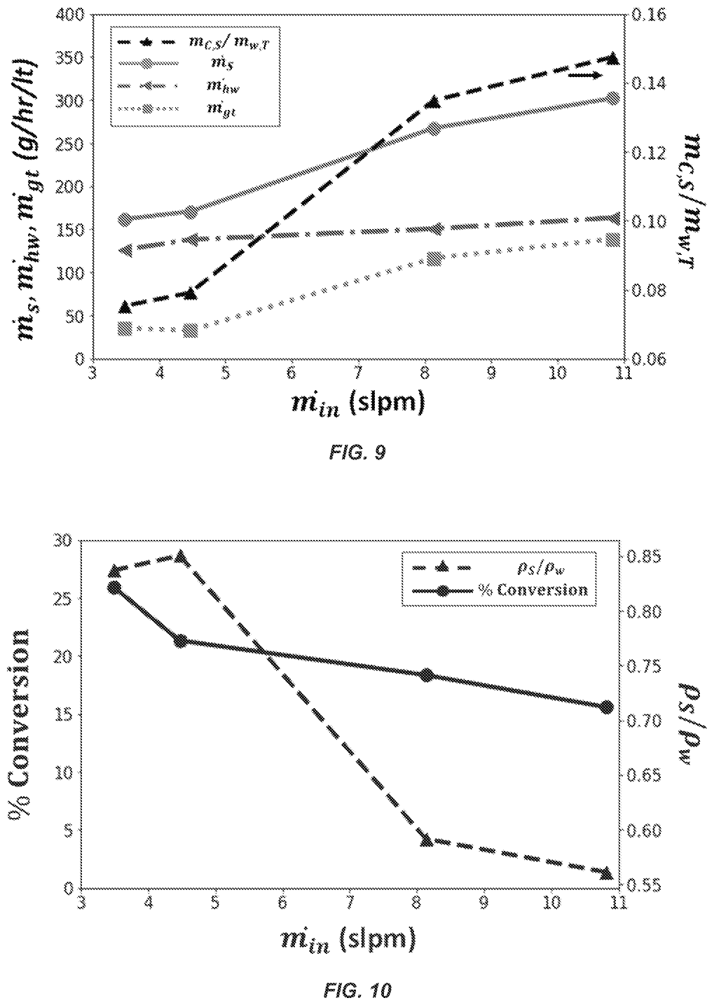

Influence of inlet gas flow rate on hydrate formation. Experiments were conducted for total flow time (tₜₒₜ) (pressurization+continuous flow) of 14 minutes at 400 psig and 2.6±0.8° C. The inlet gas flow rate (\dot{m}ᵢₙ) was varied in the range 3.5-10.8 slpm. Higher flow rate is expected to increase hydrate formation significantly due to enhanced mass transfer, breakage of hydrate shells and better heat removal. Indeed, FIG. 9 shows that sequestration rate (\dot{m}_{S}) increases with flow rate, thus sequestering more CO₂ per unit mass of water (m_{C,S}/m_{w,T} shown in secondary y-axis). Upon assuming that all the trapped gas would eventually convert into hydrate as the slurry is transported, this suggests that the water is better utilized creating a higher hydrate wt % slurry for sequestration application. The sequestration rate is the sum of the amount of unreacted trapped gas (\dot{m}_{gt}) and the amount of gas converted to hydrates (\dot{m}_{hw}). It is found that the rate at which gas converts to hydrates (\dot{m}_{hw}) increases only by <10% for >3× increase in the gas flow rate. It is observed that at high inlet flow rates, fresh hydrate shells stick and eventually coalesce with the hydrate bulk due to the upward momentum of the incoming gas. This causes an increase in volume, accompanied by an increase in the amount of unreacted trapped gas. Therefore, the overall increase in sequestration rate in hydrate slurry is primarily due to this increase in trapped unreacted gas (\dot{m}_{gt}). This suggests that mechanisms enhancing mass transfer may further increase hydrate formation. Addition of mechanical agitation or use of sprays can facilitate breakup of hydrate shells and enhance hydrate formation.

The energy used to produce a hydrate slurry and the quality of the slurry may also change with increasing inlet gas flow rate. The energy usage depends on the power to pump gas and the need for recirculation, which in turn depends on the conversion fraction of CO₂ to hydrates in a single pass. This conversion fraction reduces with increasing flow (FIG. 10). The conversion fraction decreases at a very slow rate from 25.%9 to 15.6% for a 308% increase in gas flow rate. In comparison the sequestration rate increases by 1.86 times for this increase in flow rate. This suggests that high flow rates may increase sequestration rate without drastically changing recirculation requirements.

The quality of the slurry produced may also change significantly with inlet gas flow rate. This slurry includes hydrate crystals, unreacted trapped gas and unreacted water. The increase in fraction of unreacted gas inside the slurry changes the quality of the slurry making it less dense (FIG. 10). While unreacted trapped gas could appear problematic, it must be realized that a lot of this trapped gas will convert to hydrates while the slurry is being transported for sequestration. Overall, FIG. 9 and FIG. 10 highlight the benefits of high flow rate sparging of CO₂ for rapid hydrate formation for sequestration.

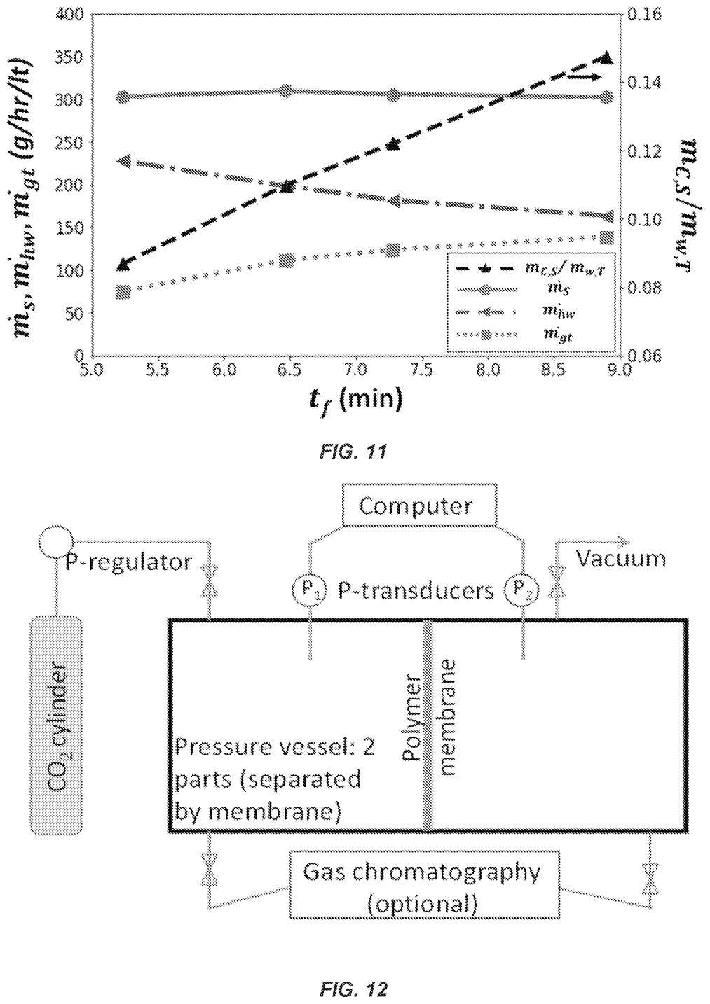

Influence of formation time. Experiments were conducted to study the influence of formation time on gas consumption rate: total flow time (tₜₒₜ) was varied from 12-15.5 minutes, with the reactor at 400 psig and 2.5±0.5° C., and flow rate of 11±1 slpm. It is seen (FIG. 11) that the total mass of CO₂ sequestered as hydrate slurry per unit mass of water (m_{C,S}/m_{w,T}) increases linearly with formation time, suggesting scalability of the approach. The sequestration rate is constant (within 305±8 g/hr/l) over this range of time. This finding is significant, as more gas can be sequestered for the same amount of water, thus better utilizing the water, by running the reactor for longer before the hydrate slurry is extracted.

It is noted that although the sequestration rate is constant over time, the slurry composition changes significantly (FIG. 11). As fresh gas forms hydrate shells attached to the existing hydrate chunk (and eventually coalesce) the amount of CO₂ as hydrate and the amount of unreacted CO₂ gas trapped in the slurry, both increases. However, the gas consumption rate of CO₂ in water (dissolved or hydrate crystal, e.g., \dot{m}_{hw}) decreases with time by ˜28% and the gas inside hydrate slurry as unreacted trapped gas (not in hydrate crystal, e.g., \dot{m}_{gt}) increases with time by 66%. This is expected since hydrate formation is exothermic, which impedes further growth. Furthermore, from a mass transfer perspective, since new hydrate comes in as a shell with unreacted CO₂ gas trapped inside it, lesser water-gas contact area is available for further hydrate formation (since most of the total unreacted trapped CO₂ gas inside slurry is inside hydrate shells without water). Breaking up this slurry can help further hydrate formation.

Hydrate formation from impure water. All experiments conducted in this study are summarized in Table 2. Experiments were conducted with saltwater (sodium chloride concentration of 3.5 wt % to mimic seawater). At 400 psig and 2.5±0.5° C., the amount of gas consumed by saltwater was 23 gm in 160 minutes; this is in contrast to 24.5 gm of gas consumption in 14 minutes for deionized (DI) water. This corresponds to the sequestration rate of CO₂ using saltwater being 22 times slower than that with deionized water. Visually, there is a noticeable difference in hydrate formation from saltwater versus DI water. Unlike the coalescence of hydrate shells with DI water, experiments with saltwater show a gradual increase in opacity of the saltwater solution over the gas flow time of 160 minutes. This causes a very low rise in slurry volume when compared to the DI water experiments. The density of the hydrate slurry block formed in 160 min from saltwater is 950 kg/m³, which is 56% higher than the slurry created by DI water at same conditions in 14 min. This is an important finding, implying that denser hydrate slurries (which require lesser compaction) can be formed with saltwater, but that the corresponding sequestration rate may be lower.

Furthermore, an experiment was conducted with tapwater to study the functionality of the method for nonpure water streams. At 400 npsig and 2.3±0.3° C., total flow time of 14 min, and gas flow rate of 10.7±0.4 slpm, a total of 27.9 g of CO₂ can be sequestered using tapwater in comparison to 24.9 g for DI water. This shows that the use of tapwater does reduce formation rate. Taken together these findings imply that while seawater-based hydrate formation could be challenging (even with the significant benefits of magnesium), implementation of this concept does not require ultrapure water use, which vastly simplifies operations and improved techno-economics.

Influence of quantity of magnesium on hydrate formation. Magnesium is a valuable addition to the described approach and an experiment was conducted to quantify the influence of the quantity of magnesium on gas consumption. This involved the use of 2 magnesium plates with each plate being 3× the size of plates used in all other experiments. The gas consumption rate was found to increase (Table 2) from 306 g/hr/l to 376 g/hr/l (23% increase) for the same conditions of 400 psig, 2.6° C., flow rate of 11±1 slpm, and total flow time of 14 min. This suggests that while more magnesium contact helps, the gains do not scale linearly. It is noted that the amount of magnesium consumed in this approach is small.

Hydrate formation during compaction stage. Here, the results of two experiments in which hydrates were allowed to compact after formation are described. It was seen that the gas consumption rate during hydrate compaction is significantly lower than that during continuous flow. A total of only 4.1 gm and 3.9 gm CO₂ was absorbed into the water (as hydrate or dissolved gas) over compaction times of 21.6 hrs and 31.5 hrs respectively. In contrast, 24.4 gm, 24.9 gm, and 24.1 gm CO₂ was captured by water in a flow time of tₜₒₜ=14 min (pressurization+continuous flow). For the cases shown in FIG. 7, the gas consumption rate during continuous flow is 306±9 g/hr/l, while that during compaction is 0.24±0.05 g/hr/l. The 1275 times enhancement in gas consumption rate for continuous flow process over a batch process, highlights the importance of continuous flow for hydrate formation.

Conclusions. Ultrafast CO₂ hydrate slurry formation in a bubble column reactor without the use of chemical promoters was studied. A metric of gas consumption rate per unit reactor volume is evaluated and is termed as the sequestration rate. The sequestration rate (as hydrate slurry) increases with more favorable thermodynamic conditions (higher pressure and lower temperature), flow rate increase and the presence of magnesium. A 3× increase in gas flow rate causes a 1.9× increase in sequestration rate; however, it decreases the single pass conversion fraction of CO₂ from 25.9 to 15.6%. Hydrate sequestration was most sensitive to the pressure; a pressure increase from 400 psig to 500 psig increased the sequestration rate by 8×. This corresponds to the highest-ever sequestration rate (via hydrates) of 2464 g/hr/l, which is at least 8 times higher than any reported sequestration rate of CO₂ via hydrate formation. Importantly, the sequestration rate remains constant over formation time, highlighting the scalability of this approach. Increasing the amount of Mg in the reactor by 6× increased the sequestration rate by 23%. Assuming scalability of this concept over time and size, 5 bubble column reactors of 10 m³ volume operating under the best conditions in this study may be useful to sequester 1 Mt/yr of CO₂, which is the scale of typical sequestration projects.

### Figure Captions for Example 2.

FIG. 6, FIG. 7, and FIG. 8 provide a summary of the experimental procedures described in this Example. FIG. 6: Time variation of reactor pressure (P_{R}), reactor temperature (T_{R}), inlet gas temperature (Tᵢₙ), and water temperature (T_{B}) during the experiment. FIG. 7: Variation of reactor pressure (P_{R}) and reactor temperature (T_{R}) for two compaction experiments and one experiment without compaction. FIG. 8, top row (panels c-i, c-ii, c-iii, and c-iv) show schematics of the reactor at different states: panel c-i, State 0: beginning of pressurization; panel c-ii, State 1: end of initial hydrate formation (after continuous gas flow); panel c-iiii, State C (Compacted state 1): after closing the inlet and outlet of reactor, and letting hydrates compact over hours; and panel c-iv, State 2: at end of hydrate dissociation. FIG. 8, bottom row (panels d-i, d-ii, and d-iii) provides images from inside the reactor at nucleation time (panel d-i), 4 min after hydrate nucleation (panel d-ii), and end of continuous flow/state 1 (panel d-iii).

FIG. 9: Influence of gas flow rate (\dot{m}ᵢₙ) on sequestration rate (\dot{m}_{S}), gas consumption for hydrate formation (\dot{m}_{hw}), gas consumption as unreacted gas trapped inside slurry (\dot{m}_{gt}), and mass of CO₂ sequestered in slurry per mass of water used (m_{C,S}/m_{w,T}).

FIG. 10: Influence of gas flow rate (\dot{m}ᵢₙ) on conversion fraction in a single pass and the density of hydrate slurry normalized with density of water (ρ_{S}/ρ_{w}; secondary y-axis).

FIG. 11: Influence of formation time (t_{f}) on sequestration rate (\dot{m}_{S}), gas consumption for hydrate formation (\dot{m}_{hw}), gas consumption as unreacted gas trapped inside slurry (\dot{m}_{gt}), and mass of CO₂ sequestered in slurry per mass of water used (m_{C,S}/m_{w,T}).

### Example 3: Aspects of Polymer Materials for Sealing CO₂ Hydrates to Prevent Dissociation During Seabed Sequestration

In some examples, use of the technology described herein employs a polymeric material that can be used to form a CO₂ impermeable sleeve around the hydrate plug. For long term storage embodiments, this material may not degrade for extended periods of time (e.g., defined as >1000 years), and is environmentally friendly and economical.

For identifying suitable components for long term CO₂ hydrate storage, various aspects are considered. Material degradation can occur on the inside (contact with CO₂ hydrate) or by the marine environment outside. While no studies exist for polymer degradation in the presence of CO₂ hydrates, there are many analogous studies on polymer degradation in supercritical CO₂ ambient, and in marine environments. Most studies on polymer degradation in seawater have largely been motivated from concerns over the increase in plastic dumped into the oceans. These studies provide insights for suitable polymeric materials for the CO₂ hydrate storage techniques described herein. The degradation of about 110 plastics in marine environment is reported literature. Top plastics in oceans today include Polyester (PET), high-density and low-density polyethylene (HDPE and LDPE), polyvinyl chloride (PVC), polypropylene (PP), and polystyrene (PS). Among these, LDPE, HDPE, and PP are well-known to degrade in marine environments. The primary degradation mechanisms include photo and thermo-oxidative degradation, thermal degradation, biodegradation and hydrolysis.

Polymers used in supercritical CO₂ (s-CO₂) applications may be useful for the present application, and there are many studies on polymer degradation in the presence of s-CO₂. It has been determined that polymers with carbonyl groups, C—F bonds, and double bonds exhibit higher CO₂ absorption. CO₂, being a weakly polar solvent, cannot dissolve highly polar or hydrogen-bonded polymers such as poly (acrylic acid). Prolonged exposure of polymers to s-CO₂ leads to degradation such as plasticization and lowering of glass transition temperature (T_{g}). Polymers with greater flexibility of backbone, high free volume, and lower T_{g} exhibit higher solubility in s-CO₂. Polymers used in s-CO₂ applications can also undergo explosive decompression leading to changes in both physical and chemical properties of the polymers.

The most commonly used polymers in s-CO₂ applications, such as Viton, Polyetheretherketone (PEEK), ethylene propylene diene monomer (EPDM), ethylene propylene rubber (EPR), Buna N, Neoprene, Teflon, and FF 202 (perfluoropolymer) have been previously evaluated. These polymers were subjected to s-CO₂ environments at 100° C. and 150° C. for 1000 hrs, and the accompanying physical and chemical changes were studied via ATR-FTIR, optical microscopy, T_{g}, storage modulus, and mass and density changes. It was found that EPDM, EPR, and FF202 had the least degradation. Importantly, EPDM is also used as a sealant for undersea shield tunnels, and EPDM and EPR are widely used in waterproofing applications. Accordingly, EPDM, EPR, and FF202 are three example polymer candidates that can be employed for CO₂ hydrate encapsulation.

Attributes of sealing polymers for leak-free, long-duration CO₂ sequestration. Various properties may be beneficial for use of this technology, and various methods can be used to test these properties. It will be appreciated that there are many other attributes of materials that can be examined. However, this Example focuses on the most relevant properties only. These properties can be measured for fresh samples and for samples which have undergone accelerated ageing in saltwater (e.g., at higher than service temperatures).

Stress-strain curve: The stress-strain curve provides information on the yield strength, ultimate tensile strength, and elastic modulus. The ultimate tensile strength is an important parameter as it determines the maximum stress that the sealed hydrate plug can handle before it ruptures. This stress may, for example, be caused due to pressure buildup within the plug due to dissociation resulting from a local temperature increase (which can be attributed to multiple reasons). Flexibility is also a relevant parameter; the hydrate block may conform to changes in shape or orientation that may be caused by marine life, ocean currents, etc. Flexible materials also transmits pressure, which may be relevant for this application. Flexibility is related to the thickness of the material and is measured as the ratio of yield strength and elastic modulus; it can thus be obtained from the stress-strain relationship.

A tensometer is generally used to obtain the stress-strain curves for the polymers of interest. Relevant standards for the testing may include ASTM D3039/D3039M. This standard suggests use of displacement transducers to measure both longitudinal and transverse strain, thereby also yielding the Poisson's ratio. The Poisson's ratio is a relevant parameter since it determines the effective thickness at a given stress, which in turn determines other mechanical properties.

Tear resistance: The tear resistance (or tear strength) is a measure of how well a material can withstand the effects of tearing. Tearing can be caused by marine life, rocks on the ocean floor, and many other reasons, making tear resistance an important property of the sealing. Tear resistance is evaluated using a standard tensometer, and relevant standards may include ASTM D624.

Weight and density measurements: Weight and density of the polymer is measured before and after ageing tests. This provides insights on polymer decomposition during ageing, and points to any permanent damage or compositional changes in the bulk polymer itself. Any dissolution of liquid/gas within the polymer can also be identified.

CO₂ impermeability: Impermeability of polymer membrane to CO₂ is another parameter relevant for preventing hydrate dissociation. Tests to verify impermeability are conducted, for example, using a setup schematically depicted in FIG. 12. This setup comprises a chamber with two partitions separated by a membrane. One side contains pressurized CO₂ gas, and the other side is evacuated. Any diffusion (leak) through the membrane will register as a pressure increase on the evacuated side. These tests can be run for extended periods of time (e.g., days to weeks) to validate the absence of leaks (or quantify the leak rate). The obtained data can also be used to estimate the diffusion coefficient of a particular polymer (e.g., based on mass diffusion model), and the permeability of the polymer (using Darcy's Law) which may allow for determination of a suitable thickness of the polymeric structure. These experiments can also be performed at elevated temperatures inside an environmental chamber.

Burst resistance: the setup depicted in FIG. 12 is also useful for measurement of the burst resistance (maximum differential pressure that can be handled by the material) of the polymer. In such evaluations, the differential pressure across the membrane is increased at a fixed rate until the membrane fails. Measuring the burst resistance is useful as there can be situations that result in a pressure differential across the hydrate-containing sleeve (hydrate dissociation, or external forces like sedimentation over sleeve). Therefore, the maximum pressure differential that the polymer can handle is an important parameter to allow for planning long term storage.

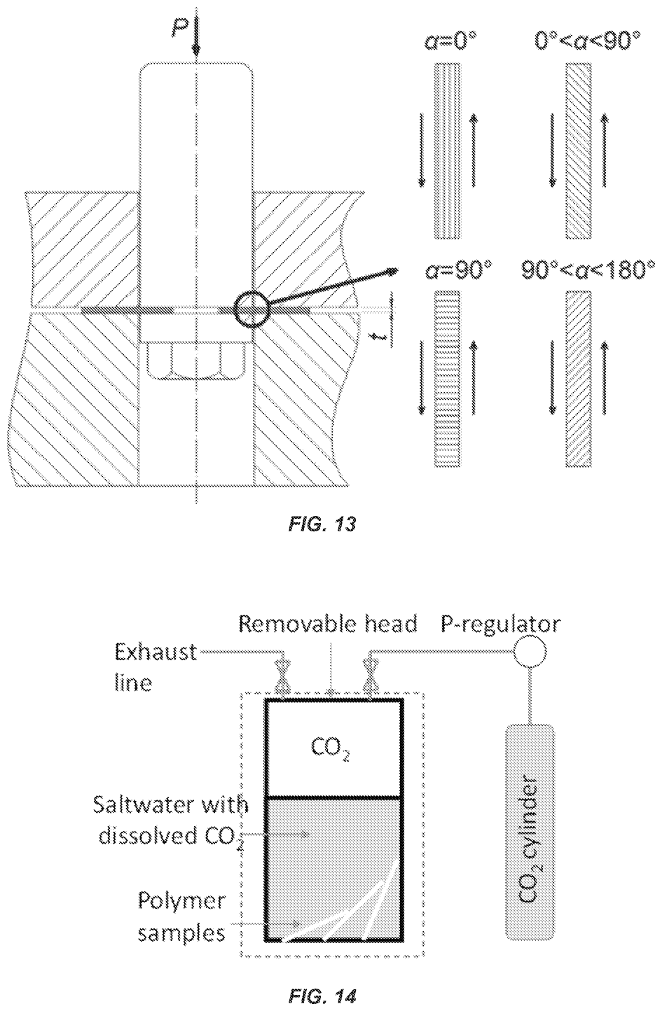

Shear strength: Shear strength describes the material's ability to resist shear from outside. A punch tool method, schematically illustrated in FIG. 13, is used to determine shear strength, such as based on ASTM D732. The force P applies a shear at an angle α from the orientation of polymer chain as illustrated. The shear stress is obtained as τ=P/πD_{P}t, where D_{P} is diameter of the pinhole.

Scanning Electron Microscopy (SEM) analysis: SEM analysis is useful to identify relevant surface topography information. Comparison of SEM images before and after any ageing tests can provide useful qualitative information about the suitability of the polymer.

Cost and CO₂ footprint: it will be appreciated that any polymer used for enclosing CO₂ hydrates for seabed carbon sequestration may result in plastic materials being introduced into the ocean, which can be undesirable and can interface with the cost and CO₂ footprint of the polymer. For the case where the hydrates have 80% cages filled, about 1 Megaton CO₂ is estimated to be stored as 1 m thick hydrate in a 3 km² area. Such an area can have numerous sleeves made of polymers. In such an example, this may result in over 6 km² area of polymer (depending upon sleeve size), resulting in costs and CO₂ footprint that may not be insignificant.

Experiments to validate ageing resistance. The polymer material is targeted at long-term sequestration (e.g., over 1000 years). Accordingly, accelerated ageing tests and related analysis are conducted to validate long-term durability of the material in seawater. Ageing of polymers is conducted, for example, in an ageing tank, schematically illustrated in FIG. 14, filled with salt water and sand to mimic the seabed. Multiple sheets of polymers are immersed in the tank, which is e pressurized with CO₂ to pressures of up to 1000 psig (e.g., corresponding to about 700 m ocean depth). The tank is then disconnected from the pressurizing cylinder and moved into an environmental chamber/oven for ageing at 4° C. (e.g., seabed temperature) and under accelerated thermal ageing conditions of 30° C., 70° C. and 90° C. In some examples, the experiments are conducted for durations as long as a month (e.g., for the 4° C. condition). After these experiments, various properties (e.g., those discussed above) are measured to quantify degradation.

The influence of temperature on aging can be modeled by the Arrhenius law, k=Ae −Eₐ/RT=d[x]/dt, where k is reaction rate constant, A is Arrhenius constant, Eₐ is activation energy, R is universal gas constant, and T is temperature. [x] is the weight of polymer, concentration of dissolved or produced gas (from degradation reaction), or degree of polymerization. The constants A and Eₐ can be determined by obtaining the reaction rate at different time intervals. The equation can be extrapolated to 4° C. to obtain predicted life of the polymer on the seabed.

Alternative test conditions include, but are not limited to:

Tests in CO₂ environment only, or tests in saltwater environment only (with N₂). These tests may optionally be used to isolate the individual impact of CO₂ and saltwater on polymer degradation.

Fixed amount of O₂ is optionally added to study thermo-oxidative degradation of the polymer.

Since CO₂ streams are often accompanied by NOₓ and SOₓ, these gases are optionally introduced (in trace amounts) to elucidate their impact on degradation.

Bio-degradation is optionally studied by the introduction of marine microorganisms, such as Bacillus pumilus, Bacillus subtilis, and/or Kocuriapalustris.

Initial results: experiments were conducted to ascertain the stability of EPDM (ethylene propylene diene monomer rubber) in a CO₂ hydrates environment. Strips of EPDM were left in a reactor with CO₂ hydrates for 18 hours (at 400 psi and 4° C.). The stress-strain curves before and after exposure overlapped with each other. Furthermore, there was no visible degradation of EPDM as per optical microscopy. These findings lend confidence to the use of a variety of polymers that have the required combination of mechanical properties and CO₂ impermeability. In some examples, one or multiple polymers used for sealing in supercritical CO₂ applications are useful for the CO₂ hydrate storage applications described herein.

Figure captions for Example 3:

FIG. 12. Experimental setup used for CO₂ permeability experiments.

FIG. 13. Shear strain measurement using punch tool method.

FIG. 14. Experimental setup used for accelerated thermal aging of polymers.

### REFERENCES

P. V. Acharya, A. Shahriari, D. Lin, and V. Bahadur, “Mechanisms underlying rapid electronucleation and freezing of hydrates,” ASME Int. Mech. Eng. Congr. Expo. Proc., vol. 8, pp. 1-6, 2017, doi: 10.1115/IMECE2017-70206.
P. V. Acharya, A. Kar, A. Shahriari, A. Bhati, A. Mhadeshwar, and V. Bahadur, “Aluminum-Based Promotion of Nucleation of Carbon Dioxide Hydrates,” J. Phys. Chem. Lett., vol. 11, no. 4, pp. 1477-1482, 2020, doi: 10.1021/acs.jpclett.9b03485.
E. Alper and O. Yuksel Orhan, “CO2 utilization: Developments in conversion processes,” Petroleum, vol. 3, no. 1, pp. 109-126, 2017, doi: 10.1016/j.petlm.2016.11.003.
A. Bhati, M. Lokanathan, S. Smaha, and V. Bahadur, “Interviews of Industry Professionals as part of NSF I-Corps Program.” 2022.
Carpenter K. and Bahadur V. Electro-nucleation for rapid and controlled formation of hydrates. J. of P. Chem. Letters, 2016, 7, 2465-2469,
Z. Chen, J. Fang, C. Xu, Z. Xia, K. Yan, and X. Li, “Carbon dioxide hydrate separation from Integrated Gasification Combined Cycle (IGCC) syngas by a novel hydrate heat-mass coupling method,” Energy, vol. 199, p. 117420, 2020, doi: 10.1016/j.energy.2020.117420.
Dashti, H., Yew, L. Z. and Lou X. Recent advances in gas hydrate-based CO₂ capture. J. Nat. Gas Sci. Engg.2015, 23, 195-207.
N. Gaikwad, G. Bhattacharjee, 0. S. Kushwaha, J. S. Sangwai, P. Linga, and R. Kumar, “Effect of Cyclooctane and 1-Tryptophan on Hydrate Formation from an Equimolar CO2-CH4Gas Mixture Employing a Horizontal-Tray Packed Bed Reactor,” Energy and Fuels, vol. 34, no. 8, pp. 9840-9851, 2020, doi: 10.1021/acs.energyfuels.0c01511.
N. Gaikwad, G. Bhattacharjee, J. S. Sangwai, R. Kumar, and P. Linga, “Kinetic and Morphology Study of Equimolar CO2-CH4Hydrate Formation in the Presence of Cyclooctane and 1-Tryptophan,” Energy and Fuels, vol. 35, no. 1, pp. 636-648, 2021, doi: 10.1021/acs.energyfuels.0c03665.
M. Golombok, E. Ineke, J. C. R. Luzardo, Y. Y. He, and P. Zitha, “Resolving CO₂ and methane hydrate formation kinetics,” Environ. Chem. Lett., vol. 7, no. 4, pp. 325-330, 2009, doi: 10.1007/s10311-008-0173-y.
S. Hashemi, A. Macchi, and P. Servio, “Gas—liquid mass transfer in a slurry bubble column operated atgas hydrate forming conditions,” Chem. Eng. Sci., 2009, vol. 64, no. 16, pp. 3709-3716.
J. He, Y. Liu, Z. Ma, S. Deng, R. Zhao, and L. Zhao, “A Literature Research on the Performance Evaluation of Hydrate-based CO₂ Capture and Separation Process,” Energy Procedia, vol. 105, pp. 4090-4097, 2017, doi: 10.1016/j.egypro.2017.03.867.
G. Hu, Y. Li, C. Ye, L. Liu, and X. Chen, “Engineering Microorganisms for Enhanced CO 2 Sequestration,” Trends Biotechnol., vol. 37, no. 5, pp. 532-547, 2019, doi: 10.1016/j.tibtech.2018.10.008.
International Energy Agency, “Energy Technology Perspectives 2020—Special Report on Carbon Capture Utilisation and Storage,” 2020. doi: 10.1787/208b66f4-en.
IEA GHG, “Gas Hydrates for Deep Ocean Storage of Co2—Hydrates for Transportation and Deep Ocean Storage of Co2—Background to the Study,” IEA Greenh. Gas R&D Program. Rep. PH4/26, no. February, 2004.
A. Kar et al., “Diffusion-based modeling of film growth of hydrates on gas-liquid interfaces,” Chem. Eng. Sci., vol. 234, p. 116456, 2021, doi: 10.1016/j.ces.2021.116456.
A. Kar et al., “Magnesium-Promoted Rapid Nucleation of Carbon Dioxide Hydrates,” ACS Sustain. Chem. Eng., vol. 9, no. 33, pp. 11137-11146, 2021, doi: 10.1021/acssuschemeng.1c03041.
A. Kar and V. Bahadur, “Analysis of coupled heat & mass transfer during gas hydrate formation in bubble column reactors,” Chem. Eng. J., vol. 452, no. P2, p. 139322, 2023, doi: 10.1016/j.cej.2022.139322.
A. Kumar, T. Sakpal, P. Linga, and R. Kumar, “Enhanced carbon dioxide hydrate formation kinetics in a fixed bed reactor filled with metallic packing,” Chem. Eng. Sci., vol. 122, pp. 78-85, 2015, doi: 10.1016/j.ces.2014.09.019.
K. S. Lackner, “A guide to CO2 sequestration,” Science (80-.)., vol. 300, no. June, pp. 1677-1678, 2003.
Lekse, C. E. Taylor, and E. P. Ladner, “Effect of bubble size and density on methane conversion to hydrate,” J. Pet. Sci. Eng., 2007 vol. 56, no. 1-3, pp. 97-100.
A. Li, L. Jiang, and S. Tang, “An experimental study on carbon dioxide hydrate formation using a gas-inducing agitated reactor,” Energy, vol. 134, pp. 629-637, 2017, doi: 10.1016/j.energy.2017.06.023.
G. Li, D. Liu, Y. Xie, and Y. Xiao, “Study on effect factors for CO2 hydrate rapid formation in a water-spraying apparatus,” Energy and Fuels, vol. 24, no. 8, pp. 4590-4597, 2010, doi: 10.1021/ef100417y.
P. Linga, R. Kumar, and P. Englezos, “Gas hydrate formation from hydrogen/carbon dioxide and nitrogen/carbon dioxide gas mixtures,” Chem. Eng. Sci., vol. 62, no. 16, pp. 4268-4276, 2007, doi: 10.1016/j.ces.2007.04.033.
P. Linga, R. Kumar, J. Dong, J. Ripmeester, and P. Englezos, “A new apparatus to enhance the rate of gas hydrate formation: Application to capture of carbon dioxide,” Int. J. Greenh. Gas Control, vol. 4, pp. 630-637, 2010, doi: 10.1016/j.ijggc.2009.12.014.
P. Linga, N. Daraboina, J. A. Ripmeester, and P. Englezos, “Enhanced rate of gas hydrate formation in a fixed bed column filled with sand compared to a stirred vessel,” Chem. Eng. Sci., vol. 68, no. 1, pp. 617-623, 2012, doi: 10.1016/j.ces.2011.10.030.
Y. T. Luo, J. H. Zhu, S. S. Fan, and G. J. Chen, “Study on the kinetics of hydrate formation in a bubble column,” Chem. Eng. Sci., 2006, vol. 62, no. 4, pp. 1000-1009, 2007
V. A. Kamath and G. D. Holder, “Dissociation heat transfer characteristics of methane hydrates,” AIChE J., vol. 33, no. 2, pp. 347-350, 1987, doi: 10.1002/aic.690330228.
Kar A., Acharya P. V., Bhati A., Mhadeshwar A., Venkataraman P., Barckholtz T., Celio H., Mangolini F. and Bahadur V. Magnesium-promoted rapid nucleation of carbon dioxide hydrates. ACS Sustainable Chem. and Eng., 9, 33, 2021.
Q. Nasir, H. Suleman, and Y. A. Elsheikh, “A review on the role and impact of various additives as promoters/inhibitors for gas hydrate formation,” J. Nat. Gas Sci. Eng., vol. 76, no. December 2019, p. 103211, 2020, doi: 10.1016/j.jngse.2020.103211.
M. F. Qureshi et al., “Laboratory demonstration of the stability of CO2 hydrates in deep-oceanic sediments,” Chem. Eng. J., vol. 432, no. October 2021, 2022, doi: 10.1016/j.cej.2021.134290.
N. Ramachandran, A. Aboudheir, R. Idem, and P. Tontiwachwuthikul, “Kinetics of the absorption of CO2 into mixed aqueous loaded solutions of monoethanolamine and methyldiethanolamine,” Ind. Eng. Chem. Res., vol. 45, no. 8, pp. 2608-2616, 2006, doi: 10.1021/ie0505716.
D. E. Riestenberg et al., “Field studies on the formation of sinking CO2 particles for ocean carbon sequestration: Effects of injector geometry on particle density and dissolution rate and model simulation of plume behavior,” Environ. Sci. Technol., vol. 39, no. 18, pp. 7287-7293, 2005, doi: 10.1021/es050125+.
C. Sahu, A. Sircar, J. S. Sangwai, and R. Kumar, “Effect of Methylamine, Amylamine, and Decylamine on the Formation and Dissociation Kinetics of CO₂Hydrate Relevant for Carbon Dioxide Sequestration,” Ind. Eng. Chem. Res., vol. 61, no. 7, pp. 2672-2684, 2022, doi: 10.1021/acs.iecr.1c04074.
A. Shahriari, P. V. Acharya, K. Carpenter, and V. Bahadur, “Metal-Foam-Based Ultrafast Electronucleation of Hydrates at Low Voltages,” Langmuir, vol. 33, no. 23, pp. 5652-5656, 2017, doi: 10.1021/acs.langmuir.7b00913.
R. Shukla, P. Ranjith, A. Haque, and X. Choi, “A review of studies on CO2 sequestration and caprock integrity,” Fuel, vol. 89, no. 10, pp. 2651-2664, 2010, doi: 10.1016/j.fuel.2010.05.012.
Sloan, D., and Koh, C. Clathrate Hydrates ofNatural Gases, CRC Press, Taylor & Francis Group, New York, N.Y, 2008.
C. Y. Sun, G. J. Chen, C. F. Ma, Q. Huang, H. Luo, and Q. P. Li, “The growth kinetics of hydrate film on the surface of gas bubble suspended in water or aqueous surfactant solution,” J. Cryst. Growth, 2007, vol. 306, no. 2, pp. 491-499.
C. Tsouris et al., “Scaled-Up Ocean Injection of CO2—Hydrate Composite Particles,” Energy and Fuels, vol. 21, pp. 3300-3309, 2007.
C. Tsouris et al., “Scaled-Up Ocean Injection of CO 2—Hydrate Composite Particles,” no. 4, pp. 3300-3309, 2008.
D. Voormeij and G. J. Simandl, “Geological, Ocean, and Mineral CO2 Sequestration Options: a Technical Review,” Geosci. Canada, vol. 31, no. 1, pp. 11-22, 2004.
F. Winnefeld, A. Leemann, A. German, and B. Lothenbach, “CO2 storage in cement and concrete by mineral carbonation,” Curr. Opin. Green Sustain. Chem., vol. 38, p. 100672, 2022, doi: 10.1016/j.cogsc.2022.100672.
XPrize Carbon Removal Competition, Technical Guidelines.
XPrize Carbon Removal Competition, Rules & Guidelines.
C. G. Xu, X. Sen Li, Q. N. Lv, Z. Y. Chen, and J. Cai, “Hydrate-based CO2 (carbon dioxide) capture from IGCC (integrated gasification combined cycle) synthesis gas using bubble method with a set of visual equipment,” Energy, vol. 44, no. 1, pp. 358-366, 2012, doi: 10.1016/j.energy.2012.06.021.
Zhao, J., Xu, K., Song, Y., Liu, W., Lam, W., Liu, Y., Xue, K., Zhu, Y., Yu, X. and Li Q. A review on researchon replacement of CH₄ in natural gas hydrates by use of CO₂. Energies 2012, 5, 399-419.
J. Zheng, K. Bhatnagar, M. Khurana, P. Zhang, B. Y. Zhang, and P. Linga, “Semiclathrate based CO2 capture from fuel gas mixture at ambient temperature: Effect of concentrations of tetra-n-butylammonium fluoride (TBAF) and kinetic additives,” Appl. Energy, vol. 217, no. October 2017, pp. 377-389, 2018, doi: 10.1016/j.apenergy.2018.02.133.
J. Zheng, Z. R. Chong, M. F. Qureshi, and P. Linga, “Carbon Dioxide Sequestration via Gas Hydrates: A Potential Pathway toward Decarbonization,” Energy and Fuels, vol. 34, no. 9, pp. 10529-10546, 2020, doi: 10.1021/acs.energyfuels.0c02309.
S. D. Zhou, Y. S. Yu, M. M. Zhao, S. L. Wang, and G. Z. Zhang, “Effect of graphite nanoparticles on promoting CO₂ hydrate formation,” Energy and Fuels, vol. 28, no. 7, pp. 4694-4698, 2014, doi: 10.1021/ef5000886.

### STATEMENTS REGARDING INCORPORATION BY REFERENCE AND VARIATIONS

All references throughout this application, for example patent documents, including issued or granted patents or equivalents and patent application publications, and non-patent literature documents or other source material are hereby incorporated by reference herein in their entireties, as though individually incorporated by reference.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific configurations that are in the prior art.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/of” means that one, all, or any combination of items in a list separated by “and/of” are included in the list; for example “1, 2 and/or 3” is equivalent to “1, 2, 3, 1 and 2, 1 and 3, 2 and 3, or 1, 2, and 3”.

Every formulation or combination of components described or exemplified can be used to practice the invention, unless otherwise stated. Specific names of materials are intended to be exemplary, as it is known that one of ordinary skill in the art can name the same material differently. It will be appreciated that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method, comprising:
subjecting CO₂ and a liquid comprising water to a clathrate hydrate formation condition to generate a clathrate hydrate comprising water and CO₂;
transporting the clathrate hydrate into a compaction chamber;
compacting the clathrate hydrate to generate a CO₂ hydrate plug; and
sealing the CO₂ hydrate plug within a container.

2. The method of claim 1, wherein the clathrate hydrate formation condition comprises a pressure of from 150 psi to 4500 psi or more, a temperature of from −25° C. to 25° C., a flow rate of the CO₂ as a plurality of bubbles of from 0.5 g/min per liter of the liquid to 400 g/min per liter of the liquid, and/or exposure of the CO₂ and the liquid to magnesium.

3. The method of claim 2, wherein the plurality of bubbles are generated by injecting the CO₂ into a sparger at a bottom of a hydrate formation vessel.

4. The method of claim 3, wherein the plurality of bubbles generated in a hydrate formation vessel are from 50 nm to 1 cm in diameter.

5. The method of claim 3, wherein excess CO₂ that is not incorporated into the clathrate hydrate is captured and recirculated into the bottom of the hydrate formation vessel.

6. The method of claim 3, wherein excess liquid that is not incorporated into the clathrate hydrate is captured and recirculated into the hydrate formation vessel.

7. The method of claim 1, wherein the CO₂ has a purity of 90% or greater.

8. The method of claim 1, wherein the CO₂ has a purity of from 10% to 90%.

9. The method of claim 1, wherein generating the clathrate hydrate comprising water and CO₂ comprises a CO₂ capture technique for removing CO₂ from a fluid stream.

10. The method of claim 9, wherein the fluid stream is a flue gas stream, a waste stream, or an exhaust stream for a combustion system or process.

11. The method of claim 1, wherein the CO₂ is a gas or a liquid.

12. The method of claim 1, further comprising disposing the container along a seabed for long term storage.

13. The method of claim 1, wherein the CO₂ hydrate plug is generated on land and is transported to a seabed for storage or wherein the clathrate hydrate is generated on land and is transported to a subsurface location for compaction, sealing, and/or storage.

14. The method of claim 1, wherein the CO₂ hydrate plug is generated at a subsurface location and is transported to a seabed for long term storage or wherein the clathrate hydrate is generated at the subsurface location and is transported to another subsurface location for compaction, sealing, and/or storage.

15. The method of claim 1, wherein subjecting the CO₂ and the liquid to the clathrate hydrate formation condition to generate the clathrate hydrate generates a slurry comprising solid clathrate hydrate, trapped gas, and unreacted water, and wherein transporting the clathrate hydrate into the compaction chamber comprises transporting the slurry to the compaction chamber.

16. The method of claim 15, wherein transporting the clathrate hydrate into the compaction chamber comprises transporting the slurry from a land or subsurface generation site to a remote subsurface compaction or sequestration site using a pipeline.

17. The method of claim 15, wherein compacting the clathrate hydrate comprises applying a force to the slurry to compact the clathrate hydrate and remove water from the clathrate hydrate to generate the CO₂ hydrate plug.

18. The method of claim 15, wherein during the transporting at least a portion of the trapped gas and unreacted water are converted to additional clathrate hydrate.

19. A system, comprising:
a hydrate formation vessel comprising a reservoir for subjecting CO₂ and a liquid comprising water to a clathrate hydrate formation condition;
one or more transport lumens in fluid communication with the hydrate formation vessel for transporting a material within the system, wherein the material is a gas, a liquid, a solid, or combinations thereof;
a compaction chamber coupled to the hydrate formation vessel for compacting a hydrate slurry from the hydrate formation vessel into a hydrate plug; and
a container positioned to receive the hydrate plug from the compaction chamber.

20.-26. (canceled)

21. An encapsulated hydrate for long-term storage comprising:
a plug comprising at least 80% CO₂ clathrate hydrate by mass; and
a container enclosing the plug.

22.-31. (canceled)
